(19) United States
(12) Patent Application Publication
(10) Pub. No.: US 2025/0062705 A1
(43) Pub. Date: Feb. 20, 2025

(54) METHOD AND APPARATUS FOR DRIVING PLURALITY OF MOTORS HAVING PARAMETER DIFFERENCES

(71) Applicant: SAMSUNG ELECTRONICS CO., LTD., Suwon-si (KR)

(72) Inventors: Junghoon LEE, Suwon-si (KR); Youngjae PARK, Suwon-si (KR); Jonghyun SHIN, Suwon-si (KR); Taeho LEE, Suwon-si (KR); Jehyung CHO, Suwon-si (KR)

(21) Appl. No.: 18/912,164

(22) Filed: Oct. 10, 2024

Related U.S. Application Data
(63) Continuation of application No. PCT/KR2023/003419, filed on Mar. 14, 2023.

(30) Foreign Application Priority Data
Apr. 11, 2022 (KR) 10-2022-0044637

(51) Int. Cl. H02P 5/74; F24F 11/52; F24F 11/88; H02P 5/50; H02P 11/06

(52) U.S. Cl. CPC H02P 5/74; F24F 11/88; H02P 5/50; H02P 11/06; F24F 11/52

(57) ABSTRACT

An air conditioner includes an inverter configured to drive a first motor for driving a first outdoor unit and a second motor for driving a second outdoor unit in parallel, and a processor. The processor is configured to determine parameters of the first motor and parameters of the second motor, compare the parameters of the first motor with the parameters of the second motor to determine whether the parameters differ by at least a certain value, and control the inverter through heterogeneous control for the first motor and the second motor based on the parameters differing by at least a certain value.

### CROSS-REFERENCE TO RELATED APPLICATIONS

This application is a continuation application, claiming priority under § 365(c), of International Application No. PCT/KR2023/003419, filed on Mar. 14, 2023, which is based on and claims the benefit of Korean patent application number 10-2022-044637 filed on Apr. 11, 2022, in the Korean Intellectual Property Office, the disclosures of which are incorporated by reference herein in their entireties.

### TECHNICAL FIELD

This disclosure relates to an inverter device and a driving method thereof for stably driving a plurality of motors which are connected to one inverter and have a parameter difference.

### BACKGROUND ART

An inverter is a power conversion device that converts alternate current (AC) power or direct current (DC) power into AC power to freely control the voltage and frequency. The application fields of inverters are so diverse that it is impossible to mention all of them, including home appliances such as washing machines, air conditioners, refrigerators, induction cooking devices, electric ovens, etc., and industrial electric devices such as elevators, escalators, moving walks, uninterruptible power supplies (UPSs), electric welders, electric cars, electric scooters, etc., which are innumerable.

As for a plurality of motors among them, parallel motor operation, by which one inverter drives the plurality of motors, is advantageous in that two kinds of loads may be driven by the single inverter.

FIG. 1 illustrates a connection diagram in which one inverter is used to drive a plurality of motors. There are only two motors shown in FIG. 1, but in a case that the motor is an induction motor, more motors may be connected to and driven by the inverter.

In FIG. 1, the inverter is shown as a device including a DC link (Vdc) and switching devices, but a rectifying unit including diodes for rectifying AC power to establish the DC link may be further included in the inverter.

An outdoor unit of the air conditioner may be taken as an example of an application where two or more motors are operated in parallel by an inverter. When a plurality of outdoor units (a plurality of motors connected to a plurality of fans, respectively) are used in an office or at home, the fans of the outdoor units are operated at the same speed, in which case the fans of the plurality of outdoor units may be driven by one inverter. As another application, for example, two motors may drive a conveyor belt in a factory. It is desirable to simultaneously drive the motors at either end of the conveyor belt, in which case the two motors may be operated in parallel by one inverter.

This parallel operation was first studied for induction motors because the induction motors were driven while being connected to the system in parallel. It is widely known that an induction motor has stable operation characteristics with respect to power with fixed voltage and fixed frequency because the inductor itself has operation slip, and such characteristics are equally applied to a situation when the inverter is used. The parallel operation of the inverter has been applied and used in various application fields that require variable-frequency operation because it is effective in reducing weight or cost of a system itself. As synchronous motors are being increasingly used recently due to high efficiency and power density, discussions on methods of driving synchronous motors in parallel are ongoing.

In a case of a parallel operation of a plurality of motors with one inverter, the plurality of motors are operated based on their identical characteristics. Hence, when there is a relatively large parameter difference (in resistance, inductance, counter electromotive force, etc.) between the plurality of motors, the motors may not be operated at an optimal control operating point, or the operation itself is not possible. As the mechanism for the parallel operation of the plurality of motors with one inverter is implemented by connecting the inverter to the plurality of motors in parallel, a current may be overly applied to a motor that is not a control target when there is a difference in characteristics between the plurality of motors, in which case operation of the motors may not be possible due to a protective operation of the system itself. Furthermore, as the parameters of the motors may change with aging of the motors, a driving method for responding to changes in parameters is required.

### DISCLOSURE

### Technical Solution

According to an embodiment of the disclosure, an air conditioner includes an inverter configured to drive a first motor for driving a first outdoor unit and a second motor for driving a second outdoor unit in parallel, a processor configured to determine parameters of the first motor and parameters of the second motor, compare the parameters of the first motor with the parameters of the second motor to determine whether they differ by at least a certain value, and control the inverter through heterogeneous control for the first motor and the second motor based on the parameters of the first motor and the parameters of the second motor differing by at least the certain value.

According to an embodiment of the disclosure, provided is a method of driving a plurality of motors in parallel in an air conditioner including an inverter, which have a difference in parameter and are used for operating outdoor units. The method includes determining parameters of a first motor for driving a first outdoor unit and parameters of a second motor for driving a second outdoor unit, comparing the determined parameters of the first motor with the parameters of the second motor to determine whether they differ by at least a certain value, and controlling the inverter through heterogeneous control for the first motor and the second motor based on the parameters of the first motor and the parameters of the second motor differing by at least the certain value.

### DESCRIPTION OF DRAWINGS

FIG. 1 illustrates a connection diagram in which one inverter is used to drive a plurality of motors.

FIG. 2A is a block diagram of a device for driving a plurality of motors in parallel according to an embodiment of the disclosure.

FIG. 2B is a block diagram of a controller in a power conversion device for driving a plurality of motors in parallel according to an embodiment of the disclosure.

FIG. 2C is a circuit diagram of a power unit and an inverter according to an embodiment of the disclosure.

FIG. 3 is a block diagram of a device for driving a plurality of motors in parallel by consideration of parameters of the plurality of motors according to an embodiment of the disclosure.

FIG. 4 is a block diagram of a configuration for displaying an error as heterogeneous control according to an embodiment of the disclosure.

FIG. 5A is a block diagram of a configuration for limiting a motor drive current for heterogeneous control according to an embodiment of the disclosure.

FIG. 5B is a diagram illustrating d-q axis current and voltage when loads and parameters of first and second motors correspond to each other according to an embodiment of the disclosure.

FIG. 5C illustrates d-q axis voltages applied to first and second motors when rotational speeds of the first and second motors are different according to an embodiment of the disclosure.

FIGS. 5D, 5E and 5F illustrate an example of increasing d1-axis current of a first motor according to an embodiment of the disclosure.

FIGS. 5G, 5H and 5I illustrate an example of decreasing d1-axis current of a first motor according to an embodiment of the disclosure.

FIGS. 6A, 6B and 6C are current waveform diagrams when two motors are driven by limiting motor drive currents for heterogeneous control according to an embodiment of the disclosure.

FIG. 7 is a block diagram of a configuration for selecting a master to be controlled for heterogeneous control according to an embodiment of the disclosure.

FIG. 8 is a block diagram of a power conversion device for performing heterogeneous control according to an embodiment of the disclosure.

FIG. 9 is a flowchart for performing heterogeneous control when a plurality of motors differ in parameter according to an embodiment of the disclosure.

FIG. 10 is a block diagram of a power conversion device according to an embodiment of the disclosure.

### MODE FOR INVENTION

Terms used herein will be described before detailed descriptions of embodiments of the disclosure are provided.

The terms are selected as common terms that are currently widely used, taking into account principles of the disclosure, which may however depend on intentions of those of ordinary skill in the art, judicial precedents, emergence of new technologies, and the like. Some terms as used herein are selected at the applicant's discretion, in which case, the terms will be explained later in detail in connection with embodiments of the disclosure. Therefore, the terms should be defined based on their meanings and descriptions throughout the disclosure.

The term “include (or including)” or “comprise (or comprising)” is inclusive or open-ended and does not exclude additional, unrecited elements or method steps. The terms “unit”, “module”, “block”, etc., as used herein each represent a unit for handling at least one function or operation, and may be implemented in hardware, software, or a combination thereof.

An embodiment of the disclosure will now be described in detail with reference to accompanying drawings so as to be readily practiced by those of ordinary skill in the art. However, an embodiment of the disclosure may be implemented in many different forms, and is not limited to that discussed herein. In the drawings, parts unrelated to the description are omitted for clarity, and like numerals refer to like elements throughout the specification.

In the disclosure, a method and an inverter control device are provided for optimally and heterogeneously controlling a plurality of motors that differ in parameter. In an embodiment of the disclosure, a plurality of motors that differ in parameter may be controlled efficiently and driven at an optimal control point.

According to an embodiment of the disclosure, an air conditioner includes an inverter configured to drive a first motor for driving a first outdoor unit and a second motor for driving a second outdoor unit in parallel, and a processor. The processor is configured to determine parameters of the first motor and parameters of the second motor, compare the parameters of the first motor with the parameters of the second motor to determine whether they differ by at least a certain value, and control the inverter through heterogeneous control for the first motor and the second motor based on the parameters of the first motor and the parameters of the second motor differing by at least the certain value.

In an embodiment, the parameters of the first motor and the parameters of the second motor include at least one of each motor's resistance, inductance and counter electromotive force.

In an embodiment, the air conditioner further includes a display, and the heterogeneous control is characterized in that the processor indicates on the display that the first motor and the second motor are different in kind.

In an embodiment, current sensors for detecting a current of the first motor and a current of the second motor is further included, and the heterogeneous control is characterized in that the processor determines that an overcurrent is caused by a difference of at least a certain value between the parameters of the first motor and the parameters of the second motor when it is determined that a current detected by at least one of the current sensors is the overcurrent which exceeds a certain current value to be controlled by the inverter.

In an embodiment, the air conditioner further includes a display, and the heterogeneous current is characterized by indicating on the display that the overcurrent is caused by a difference of at least a certain value between the parameters of the first motor and the parameters of the second motor.

In an embodiment, the heterogeneous control is characterized in that the processor controls the inverter by differently setting a limit value of a drive current of the first motor and a limit value of a drive current of the second motor based on the parameters.

In an embodiment, the processor is characterized by independently controlling a q-axis current and a d-axis current of one of the first motor and the second motor whose drive current is to be limited, in limiting the drive current of the first motor or the second motor to be equal to or smaller than the limit value of the drive current of the first motor or the limit value of the drive current of the second motor.

In an embodiment, the heterogeneous control is characterized in that the processor sets a sum of the limit value of the drive current of the first motor and the limit value of the drive current of the second motor to be equal to or smaller than a limit value of a drive current of the inverter.

In an embodiment, processor is characterized by controlling the inverter so that a larger one of the limit value of the drive current of the first motor and the limit value of the drive current of the second motor is smaller than a demagnetization level current of the first motor or the second motor.

In an embodiment, the heterogeneous control is characterized in that the processor selects one of the first motor and the second motor as a master to be controlled.

In an embodiment, the processor is characterized by selecting a motor with greater torque from among the first motor and the second motor as a master to be controlled with consideration for a difference in parameters between the first and second motors.

In an embodiment, the processor is characterized by selecting a motor with a larger current flowing thereto from among the first motor and the second motor as a master to be controlled with consideration for both a difference in parameters between the first and second motors and loads of the first and second motors.

In an embodiment, the processor is characterized by performing compensation control on a d-axis current of a motor which is a master to be controlled among the first and second motors when there is a speed difference between the first and second motors.

In an embodiment, when a difference between the parameters of the first motor and the parameters of the second motor causes a difference between torque of the first motor and torque of the second motor and a difference in speed between the first and second motors, the rotational speed of the second motor being higher than the rotation seed of the first motor, the processor is characterized by compensating a d-axis current of the first motor to reduce the torque of the second motor.

In an embodiment, when a difference between the parameters of the first motor and the parameters of the second motor causes a difference between torque of the first motor and torque of the second motor, and the loads of the first and second motors differ from each other, the first and second motors are driven to minimize a conduction loss based on the difference in parameter.

In an embodiment, when a difference between the parameters of the first motor and the parameters of the second motor causes a difference in torque and speed between the first and second motors, the rotational speed of the second motor being lower than the rotation seed of the first motor, the processor is characterized by compensating a d-axis current of the first motor to increase the torque of the second motor.

In an embodiment, the difference in speed between the first and second motors is caused by a difference in parameters between the first and second motors and a difference in load between the first and second motors.

According to an embodiment of the disclosure, a method of driving a plurality of motors in parallel in an air conditioner including an inverter, which have a difference in parameters and are used for operating outdoor units, includes determining parameters of a first motor for driving a first outdoor unit and parameters of a second motor for driving a second outdoor unit, comparing the parameters of the first motor with the parameters of the second motor to determine whether they differ by at least a certain value, and controlling the inverter through heterogeneous control for the first motor and the second motor based on the parameters of the first motor and the parameters of the second motor differing by at least the certain value.

In an embodiment, the controlling of the inverter through heterogeneous control includes controlling the inverter by differently setting a limit value of a drive current of the first motor and a limit value of a drive current of the second motor based on the determined parameters.

In an embodiment, the method further includes performing compensation control on a d-axis current of a motor which is a master to be controlled among the first and second motors, based on a speed difference between the first and second motors.

According to an embodiment of the disclosure, an air conditioner system of driving a plurality of motors in parallel is provided. In an embodiment of the disclosure, the air conditioner system includes first and second outdoor units and first and second motors. In an embodiment of the disclosure, the air conditioner system includes an inverter configured to drive in parallel the first motor for driving the first outdoor unit and the second motor for driving the second outdoor unit. In an embodiment of the disclosure, the air conditioner system includes a processor which determines parameters of the first motor and parameters of the second motor. In an embodiment of the disclosure, the air conditioner system includes the processor which compares the parameters of the first motor with the parameters of the second motor to determine whether the parameters of the first motor and the parameters of the second motor differ by at least a certain value. In an embodiment of the disclosure, the air conditioner system includes the processor which controls the inverter through heterogeneous control for the first motor and the second motor based on the parameters of the first motor and the parameters of the second motor differing by at least the certain value.

In an embodiment of the disclosure, the parameters of the first motor and the parameters of the second motor in the air conditioner system include at least one selected from a group of each motor's resistance, inductance and counter electromotive force.

In an embodiment of the disclosure, the air conditioner system includes current sensors detecting a current of the first motor and a current of the second motor. In an embodiment of the disclosure, the heterogeneous control of the air conditioner system is characterized in that the processor may determine, when a current detected by at least one of the current sensors is an overcurrent that exceeds a certain current value to be controlled by the inverter, that the overcurrent is caused by a difference of at least a certain value between the parameters of the first motor and the parameters of the second motor.

In an embodiment of the disclosure, the heterogeneous control of the air conditioner system is characterized in that the processor may control the inverter by differently setting a limit value of a drive current of the first motor and a limit value of a drive current of the second motor based on the parameters of the first motor and the parameters of the second motor.

In an embodiment of the disclosure, the heterogeneous control of the air conditioner system is characterized in that the processor may select one of the first motor and the second motor as a master to be controlled.

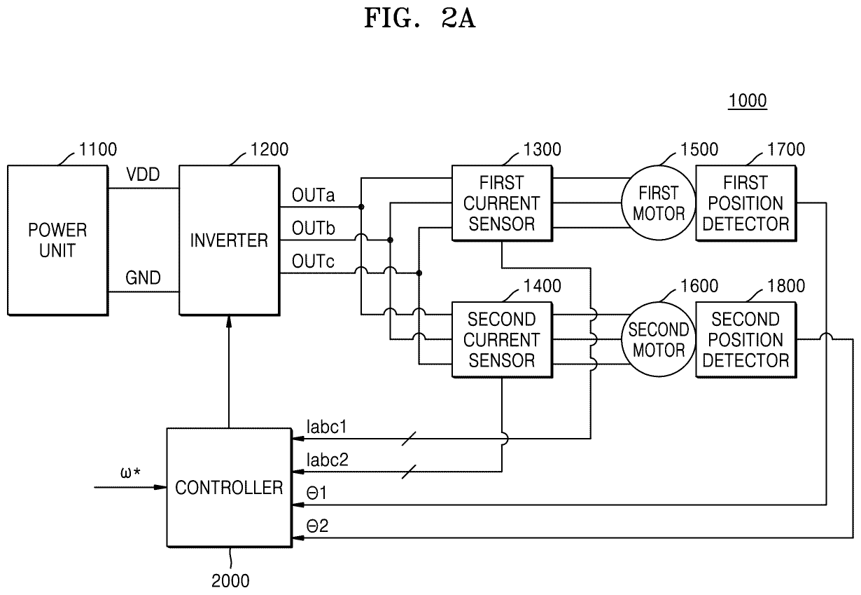

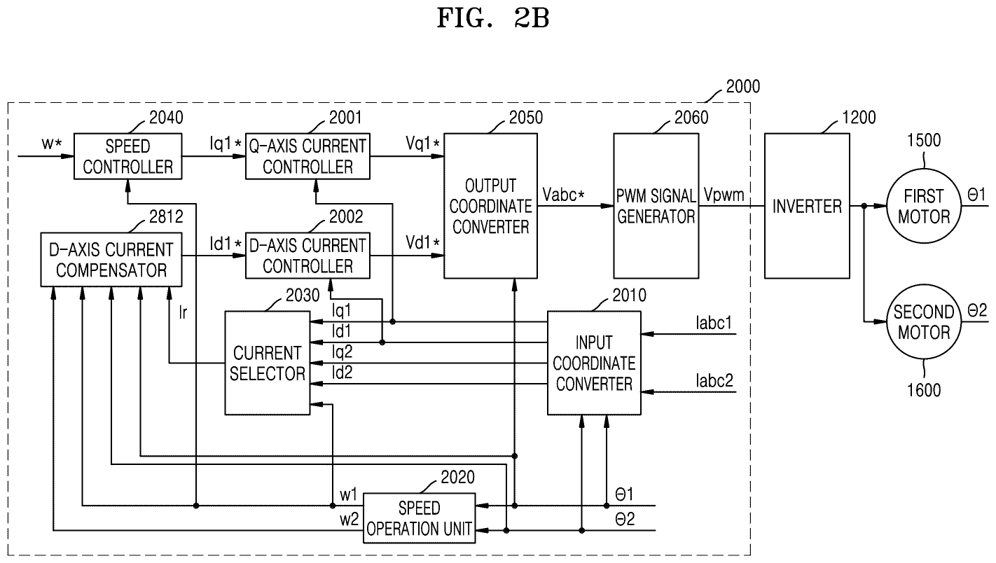

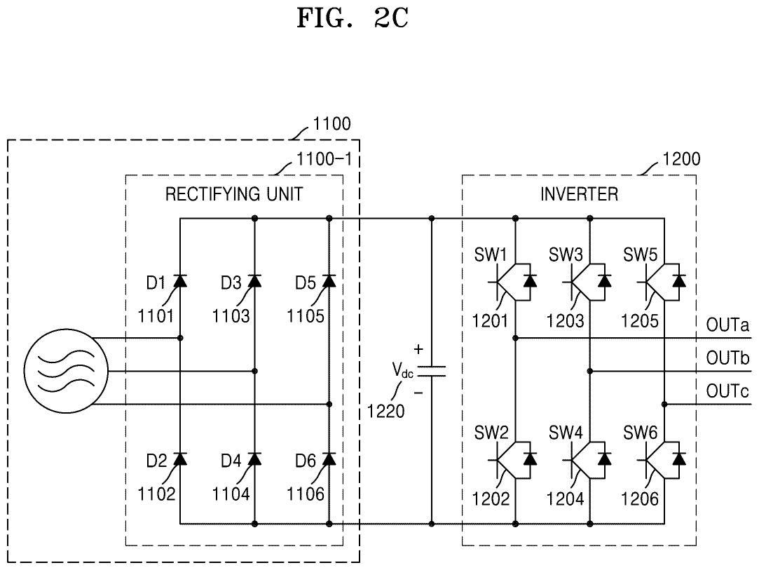

FIG. 2A is a block diagram of a device for driving a plurality of motors in parallel, according to an embodiment of the disclosure.

A power conversion device 1000 includes a power unit 1100 for supplying power, an inverter 1200, a controller 2000, a first current sensor 1300, a second current sensor 1400, a first motor 1500, a second motor 1600, a first position detector 1700, and a second position detector 1800.

The power unit 1100 supplies direct current (DC) power to the inverter 1200.

An input to the power unit 1100 may be three-phase alternate current (AC) power or single-phase AC power. For example, when the first motor 1500 and the second motor 1600 correspond to two outdoor units of an air conditioner used at a home, the input to the power unit 1100 may be the household single-phase AC power of 220 V. In an embodiment, when the first motor 1500 and the second motor 1600 are equipped at either end of a conveyor belt installed in a factory, the input to the power unit 1100 may be the three-phase AC power for commercial products that use the three-phase AC power input because the three-phase AC power is usually available for factories. Optionally, the power unit 1100 may further include a DC-DC converter for converting rectified DC power to a suitable level.

A rectifying unit included in the power unit 1100 and the inverter 1200 will be described in more detail with reference to FIG. 2C.

FIG. 2C is a circuit diagram of the power unit 1100 of FIG. 2A and the inverter 1200, according to an embodiment of the disclosure.

Referring to FIG. 2C, the input power to the power unit 1100 is shown as being three-phase, but is not limited thereto. When the power supplied to the power unit 1100 is single-phase power, a rectifying unit 1100-1 does not require six rectifying diodes but require only four rectifying diodes.

In FIG. 2C, the input power to the power unit 1100 is assumed to be three-phase, and the power unit 1100 includes the rectifying unit 1100-1 including six rectifying diodes 1101, 1102, 1103, 1104, 1105 and 1106 for rectifying the three-phase AC power. A rectified DC voltage is smoothed by a DC link capacitor 1220.

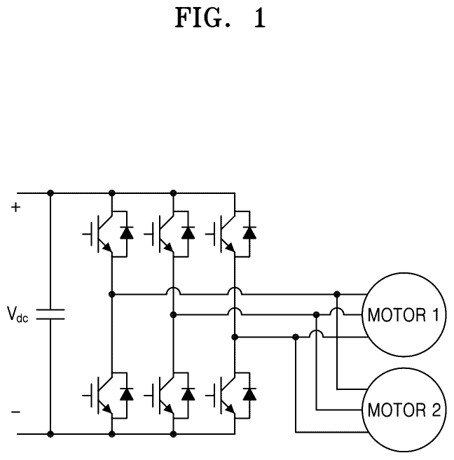

As described above in connection with FIGS. 1A and 1B, the inverter 1200 includes six switching devices SW1 1201, SW2 1202, SW3 1203, SW4 1204, SW5 1205 and SW6 1206 that switch a DC link voltage Vdc established by pulse width modulation (PWM) by the DC link capacitor 1220. For the switching devices SW1 1201, SW2 1202, SW3 1203, SW4 1204, SW5 1205 and SW6 1206, high-speed switchable transistors, field effect transistors (FETs) or insulated gate bipolar transistors (IGBTs) may be used, but the disclosure is not limited thereto, and any switching devices capable of high-speed switching may be used.

Turning back to FIG. 2A, parallel control over a plurality of motors with the inverter 1200 will now be described.

The inverter 1200 drives the first motor 1500 and the second motor 1600 by opening and closing the switching devices SW1 1201, SW2 1202, SW3 1203, SW4 1204, SW5 1205 and SW6 1206 of FIG. 2C according to a PWM signal from the controller 2000. The first motor 1500 and the second motor 1600 may employ induction motors or synchronous motors, but are not limited thereto and any AC motors that are driven by an inverter may be used.

In an embodiment of the disclosure, the first position detector 1700 and the second position detector 1800 may be used for measuring speeds of the first and second motors 1500 and 1600, without being limited thereto. It is also possible to estimate the speeds of the first and second motors 1500 and 1600 according to a speed estimation method without the position detector for the motors as in sensorless control.

In the power conversion device 1000, the controller 2000 controls the inverter 1200 by calculating rotational speed of the first motor 1500 based on a rotor position θ1 detected by the first position detector 1700 and calculating rotational speed of the second motor 1600 based on a rotor position θ2 detected by the second position detector 1800. The first position detector 1700 and the second position detector 1800 may include hall sensors or Hall effect sensors (hereinafter referred to as “hall sensors”) for detecting magnetic fields produced by the rotors. The hall sensors are arranged at proper positions on the stators included in the first and second motors 1500 and 1600 to detect changes in magnetic field due to rotation of the rotors, and detect positions of the rotors based on the detected magnetic fields. In an embodiment, the first and second position detectors 1700 and 1800 may include encoders for detecting rotations of the first and second motors 1500 and 1600. The encoder may output a pulse-shaped signal with rotation of the rotor of the motor, and calculate rotational displacement and rotational speed of the rotor based on the cycle and number of the pulses. In an embodiment, the first position detector 1700 and the second position detector 1800 may include resolvers for detecting rotation of the rotors.

In an embodiment, the first position detector 1700 and the second position detector 1800 may calculate a rotor position θ1 of the rotor of the first motor 1500 and a rotor position θ2 of the rotor of the second motor 1600 based on a drive current Iabc1 of the first motor 1500 and a drive current Iabc2 of the second motor 1600 detected by the first current sensor 1300 and the second current sensor 1400. The controller 2000 generates PWM control signals to control the inverter 1200 based on the rotor position θ1 and the rotor position θ2 of the rotors of the first motor 1500 and the second motor 1600, the drive current Iabc1 of the first motor 1500 and the drive current Iabc2 of the second motor 1600.

The controller 2000 may control the inverter 1200 such that the rotational speed of the first motor 1500 corresponds to the rotational speed of the second motor 1600 when the rotational speed of the first motor 1500 differs from the rotational speed of the second motor 1600.

However, this control method is performed on the assumption that parameters (rotor resistance of the motor, stator resistance of the motor, stator inductance of the motor, counter electromotive force, etc.) of the first and second motors 1500 and 1600 are the same. When the parameters of the first and second motors 1500 and 1600 differ from each other, the first and second motors 1500 and 1600 may not operate at an optimal control operation point or operation of one of the motors may not be possible.

Hence, there is a need for a control system to identify parameters of a plurality of motors connected in parallel with the inverter 1200 and, based on this, prevent abnormal operation when there is a difference in one or more parameters between the motors. When the difference in the one or more parameters between the motors exceeds a certain threshold, the motor operation may be stopped by limiting an operation of the inverter 1200. In an embodiment, when a protective operation occurs due to a current flowing to one of the motors being greater by a certain value, the controller 2000 for controlling the inverter 1200 may change the operation method for the inverter 1200 by confirming that the protective operation occurs due to a big difference in parameter between the motors. The controller 2000 may control the inverter 1200 based on the identified parameters to stably drive the plurality of motors connected to the inverter 1200 in parallel at the optimal control operation point at which the conduction loss is minimized, recognize a fault of a motor when required and dynamically respond to this.

Throughout the specification, the controller 2000 may be implemented with one or more processors. The processor may have an artificial intelligence (AI) processor mounted therein. The AI processor may be manufactured into the form of a dedicated hardware chip for AI, or manufactured as a portion of the existing universal processor (e.g., a CPU or an application processor) or a graphic-dedicated processor (e.g., a GPU) and mounted in the power conversion device 1000.

FIG. 2B is a block diagram of a controller in a power conversion device for driving a plurality of motors in parallel, according to an embodiment of the disclosure.

The controller 2000 of FIG. 2A is represented in more detail in FIG. 2B.

In the embodiment of FIG. 2B, the controller 2000 includes a speed controller 2040, a q-axis current controller 2001, a d-axis current controller 2002, a d-axis current compensator 2812, an input coordinate converter 2010, a speed operation unit 2020, a current selector 2030, an output coordinate converter 2050 and a PWM signal generator 2060.

The speed operation unit 2020 calculates rotational speed w1 of the first motor 1500 based on a difference in phase per hour measured from the first motor 1500. The difference in phase per hour of a motor may be usually measured using a hall sensor, or estimated by calculation while monitoring current and voltage values during the operation of the motor without the hall sensor. In an embodiment, the speed of the first motor 1500 may be measured by an encoder mounted on the rotor of the first motor 1500, but is not limited thereto and motor speed may be determined in various methods that measure or estimate, by calculation, the speed of the motor. Likewise, the speed operation unit 2020 determines rotational speed w2 of the second motor 1600 based on a difference in phase θ2 per hour measured from the second motor 1600.

The input coordinate converter 2010 converts the three-phase currents Iabc1 and Iabc2 of the first and second motors 1500 and 1600 to a d-axis current and a q-axis current on a d-q axis orthogonal coordinate system. As the sum of three-phase currents is usually constant, the three-phase current has only two variables in the three-phase driving system, which may be expressed by a d-axis current and a q-axis current. The d-axis refers to an axis in a direction commonly corresponding to a direction of a magnetic field produced by the rotor of the motor, and the q-axis refers to an axis in a direction ahead by 90 degrees of a direction of the magnetic field produced by the rotor. The 90 degrees refer not to a mechanical angle of the rotor but to an electrical angle obtained by converting an angle between neighboring N poles or neighboring S poles included in the rotor into 360 degrees. When the motor is usually represented in three phases U, V and W, the d-axis is selected as a direction of magnetic flux produced from the U-phase winding on the stator. Accordingly, the d-axis becomes a reference axis in vector control.

The q-axis is an axis perpendicular to the d-axis, and becomes a current axis corresponding to torque. Accordingly, to control the motor current, the q-axis current is controlled. Equation 1 is a d-q axis transformation matrix T(θ) that rotates the U, V and W phases at an arbitrary rotational speed ω(θ/t).

$$T ( θ ) = \frac{2}{3} [ \begin{matrix}cos θ & cos ( θ - \frac{2}{3} π ) & cos ( θ - \frac{4}{3} π ) \\ - sin θ & - sin ( θ - \frac{2}{3} π ) & - sin ( θ - \frac{4}{3} π ) \\ \frac{1}{2} & \frac{1}{2} & \frac{1}{2}\end{matrix} ] \qquad ( Equation 1 )$$

Although not shown in FIG. 2B, the input coordinate converter 2010 converts the three-phase voltages Vabc1 and Vabc2 of the first and second motors 1500 and 1600 as inputs to d-axis voltages Vd1 and Vd2 and q-axis voltages Vd1 and Vd2 through the d-q axis orthogonal coordinate system.

The d-axis voltage Vd, the q-axis voltage Vq, the d-axis current Id and the q-axis current Iq have relations as in equation 2:

$$[ \begin{matrix}{R}_{S} & - {w}_{r} {L}_{S} \\ {w}_{r} {L}_{S} & {R}_{S}\end{matrix} ] [ \begin{matrix}{I}_{dk} \\ {I}_{qk}\end{matrix} ] + [ \begin{matrix}0 \\ {w}_{r} {λ}_{f}\end{matrix} ] = [ \begin{matrix}{V}_{dk} \\ {V}_{qk}\end{matrix} ] \qquad ( Equation 2 )$$

In equation 2, Vdk is a d-axis voltage of a k-th motor, Vqk is a q-axis voltage of the k-th motor, Rs is a coil resistance of the stator of the motor, Ls is a coil inductance of the stator, λ_{f} is magnetic flux of a permanent magnet included in the rotor of the motor, or is a rotational speed of the rotor, Idk is a d-axis current of the k-th motor and Iqk is a q-axis current of the k-th motor.

In this case, when the resistances of the coils included in the stators of the first and second motors 1500 and 1600 are ignored, torque Te of the first and second motors 1500 and 1600 is as in equation 3:

$${T}_{e} = \frac{3}{2} \frac{P}{2} {λ}_{f} {I}_{qk} = \frac{3}{2} \frac{P}{2} \frac{{λ}_{f} {V}_{dk}}{{L}_{S} {w}_{r}} \qquad ( Equation 3 )$$

In equation 3, Te is a torque of the motor, P is the number of poles of the rotor, λ_{f} is magnetic flux of a permanent magnet included in the rotor of the motor, Ls is a coil inductance of the stator, ωᵣ is a rotational speed of the rotor, and Iqk is a q-axis current of the k-th motor.

According to equation 3, the torque Te of the first and second motors 1500 and 1600 depends on the q-axis current. Hence, when the loads of the first and second motors 1500 and 1600 correspond to each other and the first and second motors 1500 and 1600 rotate at the same speed, the controller 2000 controls the three-phase (a, b and c) drive voltage Vabc such that the q-axis current Iqk is applied according to the loads of the first and second motors 1500 and 1600 and the d-axis current Idk becomes ‘0’.

Furthermore, the input coordinate converter 2010 converts the three-phase current Iabc1 (Ia1, Ib1 and Ic1) input to the first motor 1500 to Iq1 and Id1 and converts the three-phase current Iabc2 (Ia2, Ib2 and Ic2) input to the second motor to Iq2 and Id2 and output them. Iq1, Id1, Iq2 and Id2 output from the input coordinate converter 2010 are input to the current selector 2030.

The d-axis current compensator 2812 outputs a d-axis current command based on speed ω1 of the first motor 1500, speed ω2 of the second motor 1600, respective phases θ1 and θ2, and a current input selected by the current selector 2030. The d-axis current controller 2002 generates a final d-axis command voltage Vd1* based on the d-axis current converted from an actually detected current by the d-q axis transformation matrix and the d-axis current command of the d-axis current compensator 2812 as inputs. The d-axis current controller 2002 usually uses, but does not exclusively use, a PI controller.

Subsequently, the speed controller 2040 having the rotational speed ω1 of the current motor which is an output from the speed operation unit 2020 and the speed command ω* as inputs generates a q-axis current command with a PI controller based on the two inputs, and the q-axis current controller 2001 generates a final q-axis command voltage Vq1* through a PI controller having the q-axis current command and the current output current Iq1 of the input coordinate converter 2010 as inputs. Although all the controllers in the previous embodiments are described as using the PI controller, it is merely an example and it is possible to use a different controller. Furthermore, FIG. 2B illustrates calculating of the final voltage command by focusing on the current and rotational speed of the first motor 1500, but the final voltage command may also be calculated by using the current and rotational speed of the second motor 1600 in another embodiment.

The generated d-axis command voltage Vd1* and q-axis command voltage Vq1* are converted to a three-phase voltage command Vabc* by the d-q axis inverse transformation matrix. Based on the three-phase voltage command Vabc* determined as the final voltage command, the PWM signal generator 2060 drives the first and second motors 1500 and 1600 by determining a switching pattern of the switching device, and based on this, applying the final PWM gate signal to the inverter 1200 to convert the rectified DC link voltage to an AC voltage.

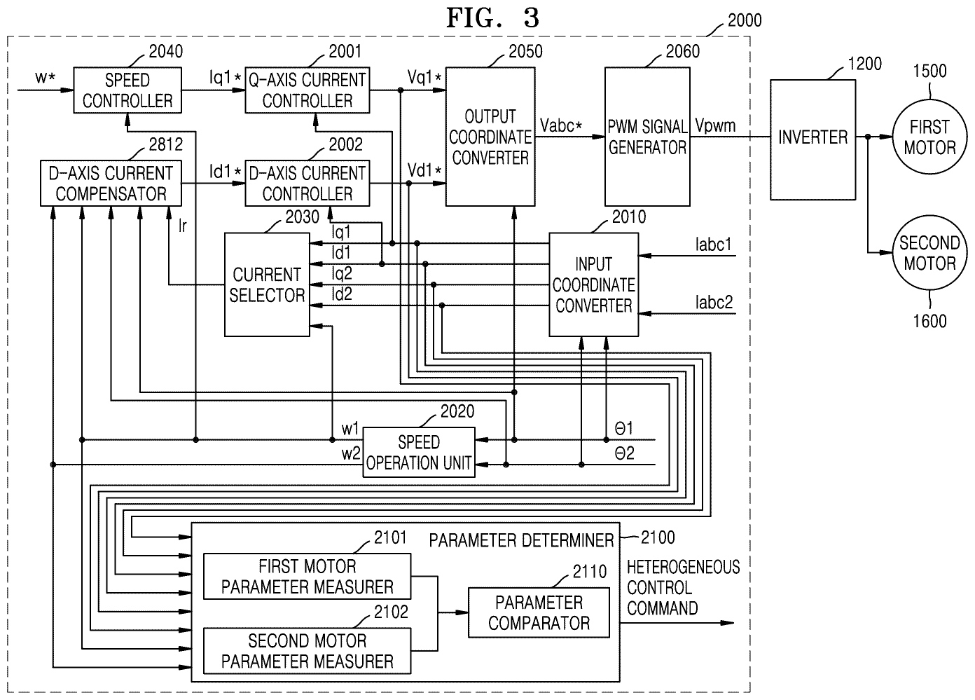

FIG. 3 is a block diagram of a device for driving a plurality of motors in parallel with consideration for parameters of the plurality of motors, according to an embodiment of the disclosure.

Unlike the block diagram of the device for parallel driving of FIG. 2B, the device for parallel driving of FIG. 3 further includes a parameter determiner 2100.

The parameter determiner 2100 determines a difference in parameter between the first and second motors 1500 and 1600 by estimating or measuring motor parameters of the first motor 1500 and the second motor 1600.

Representative parameters of the motor include a winding resistance of the motor, a winding inductance of the motor and a counter electromotive force constant of the motor, without being limited thereto. There is a way of measuring the resistance and inductance as the motor parameters while the motor is not operating, but in an embodiment of the disclosure, the motor parameters may be estimated or measured in real time while the first and second motors 1500 and 1600 are operated in parallel. As the voltages applied to the first and second motors 1500 and 1600 are known and the currents flowing in the first and second motors 1500 and 1600 may be detected by the first and second current sensors 1300 and 1400, respectively, while the first and second motors 1500 and 1600 are operated in parallel, the motor parameters may be estimated or measured in real time while the first and second motors 1500 and 1600 are operated in parallel.

Many methods of estimating or measuring the motor parameters have been suggested. For example, the stator resistance and inductance may be measured as a ratio of the voltage and current obtained when only the d-axis current is applied to measure the stator resistance of the motor. A rotor resistance of the motor may be commonly obtained by a locked rotor test without an inductance component, and the rotor inductance may be obtained by a no-load test. The counter electromotive force V_{EMF} is proportional to the rotational speed w, and thus may be obtained by multiplying an already-known counter electromotive force constant K_{E} by the rotational speed w.

V_{EMF}=K_{E}*w (Equation 4)

The above method of estimating or measuring the motor parameter is merely an example, and other various methods of estimating or measuring the motor parameter in real time may be used.

The parameter determiner 2100 includes a first motor parameter measurer 2101 for measuring one or more parameters of the first motor 1500 and a second motor parameter measurer 2102 for measuring one or more parameters of the second motor 1600. However, this is an occasion when it is assumed that there are two motors to be operated in parallel, but when there are three or more motors to be operated in parallel, a third motor parameter measurer, . . . , and an N-th motor parameter measurer may be further included, where N is a natural number greater than 3, to measure one or more parameters of the third-N motors.

The parameter determiner 2100 further includes a parameter comparator 2110. The parameter comparator 2110 compares one or more parameters of the first motor 1500 measured by the first motor parameter measurer 2101 with corresponding one or more parameters of the second motor 1600 measured by the second motor parameter measurer 2102. The comparing of parameters in the parameter comparator 2110 may be performed in various methods. In an embodiment, when the comparing of resistances, inductances, or counter electromotive forces of the plurality of motors results in more than a certain error value, the parameter comparator 2110 determines that the first motor 1500 and the second motor 1600 do not have the same parameter, and generates a command output for heterogeneous control. The command output for heterogeneous control will now be described in detail. When the parameter comparator 2110 compares parameters of the plurality of motors, the parameter comparator 2110 may generate a command output for heterogeneous control when even one of the parameters exceeds the certain error value, or generate a command output when a certain number of parameters exceed the error value. The certain error value may be a percent (%) value (e.g., among the parameters, the counter electromotive forces of the first and second motors differ by at least 10%).

The command for heterogeneous control to be output when the parameter comparator 2110 determines that the first motor 1500 and the second motor 1600 do not have the same parameter will now be described.

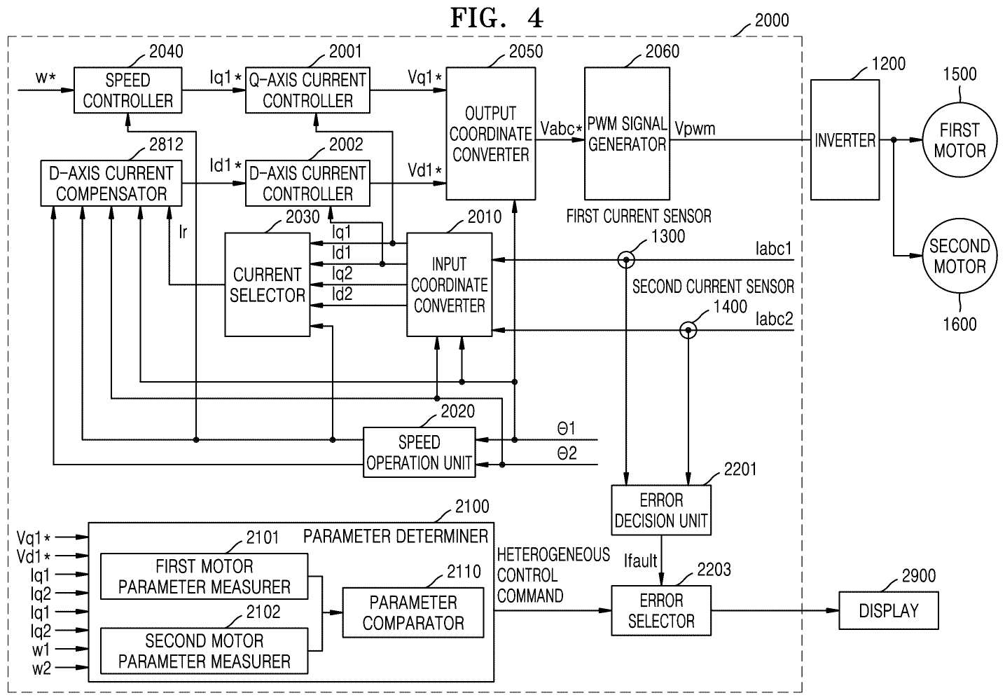

FIG. 4 is a block diagram of a configuration for displaying an error for heterogeneous control, according to an embodiment of the disclosure.

Referring to FIG. 4, the parameter comparator 2110 determines that both the first motor 1500 and the second motor 1600 do not have the same parameter (or have corresponding one or more differing parameters) and generates a command output for heterogeneous control.

An error decision unit 2201 detects an overcurrent that occurs when at least one of the first and second motors 1500 and 1600 is not controlled with a desired current by detecting the respective currents flowing to the first motor 1500 and the second motor 1600 through the first and second current sensors 1300 and 1400, respectively.

The error decision unit 2201 notifies the overcurrent detection result from the overcurrent to the error selector 2203. Based on the heterogeneous control command generated as a result of the first motor 1500 and the second motor 1600 not having the same parameter and the overcurrent detection result received from the error decision unit 2201, the error selector 2203 determines that the overcurrent occurring when at least one of the first motor 1500 and the second motor 1600 is not currently controlled with the desired current is an error caused by a difference in parameter between the first motor 1500 and the second motor 1600.

In FIG. 4, the power conversion device 1000 of FIG. 2A including the controller 2000 may further include a display 2900. The display 2900 may display an indication that the first and second motors 1500 and 1600 are different in kind when the parameters compared between the first motor 1500 and the second motor 1600 differ by at least a certain value.

In an embodiment, the controller 2000 may indicate on the display 2900 that the overcurrent detected by the current sensor is caused by the difference of at least the certain value between the parameter of the first motor 1500 and the parameter of the second motor 1600. For example, as in the previous case, the controller 2000 may display a message ‘second motor overcurrent detected—parameter difference occurs between motors’ on the display 2900. Although the content of the message may be different, the power conversion device 1000 may notify the user that overcurrent and step-out currently occurring from at least one of the motors are due to the difference in parameter between the first motor 1500 and the second motor 1600 through the display 2900.

As such, when the power conversion device 1000 recognizes the parameter difference between the first motor 1500 and the second motor 1600 and notifies the user of this, the user may recheck or find a fault in an assembly process of misassembling the motor in the product line, and quickly determine and resolve a cause of the fault by determining a change in characteristics of the motor caused by aging or external damage of the motor during the operation of the motor.

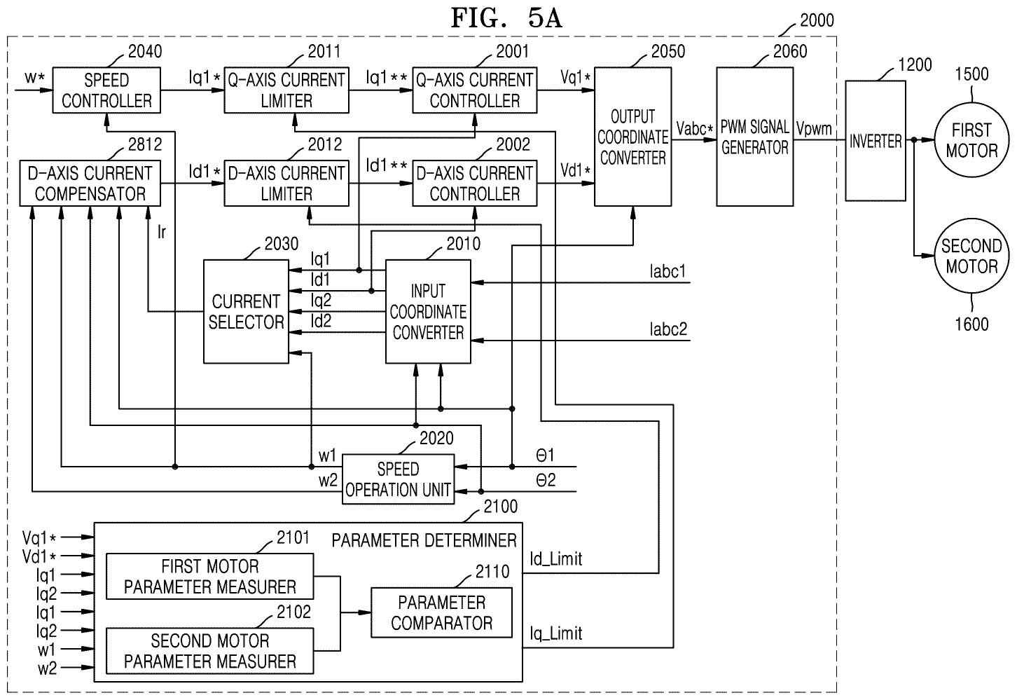

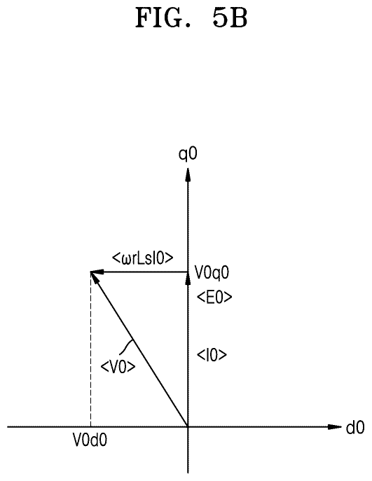

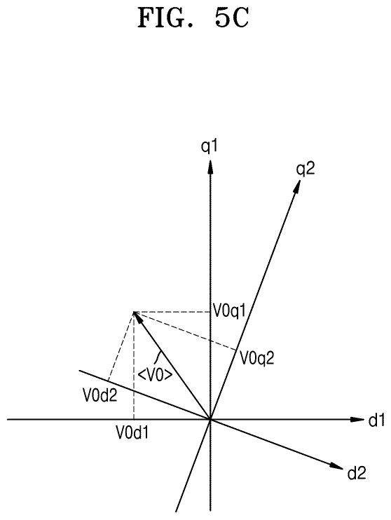

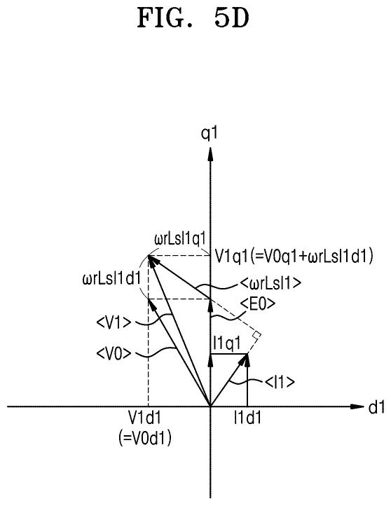

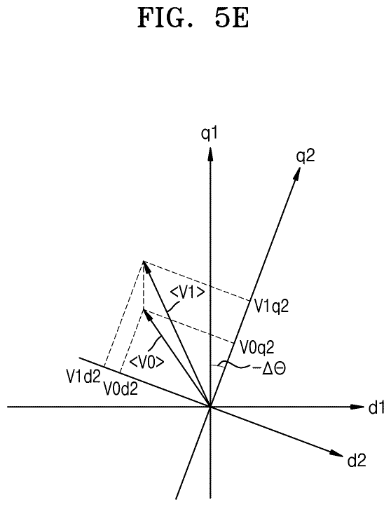

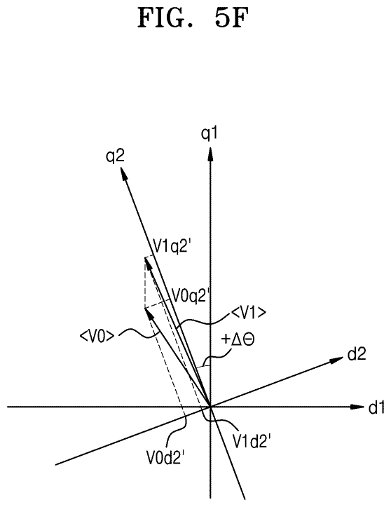

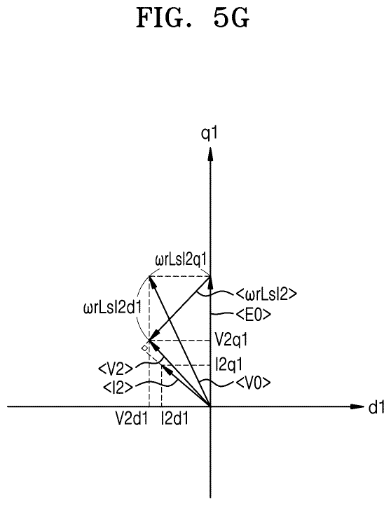

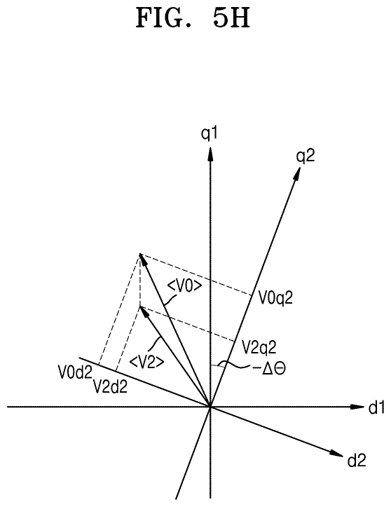

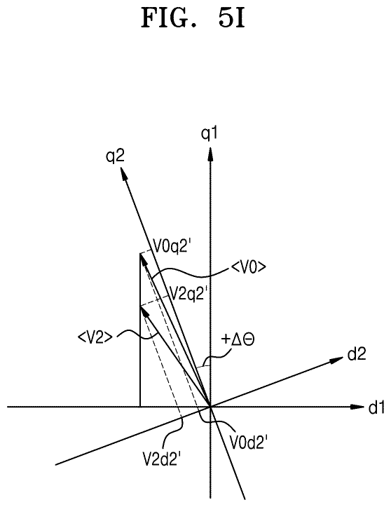

FIG. 5A is a block diagram of a configuration for limiting a motor drive current for heterogeneous control, according to an embodiment of the disclosure.

Referring to FIG. 5A, the parameter comparator 2110 determines that the first motor 1500 and the second motor 1600 do not have the same parameter, and generates a command output for heterogeneous control. In this case, the command for heterogeneous control is a d-axis current limit (id_Limit) command and a q-axis current limit command (iq_Limit). In an embodiment, the d-axis current limit (id_Limit) command may include a d-axis current limit value and the q-axis current limit command (iq_Limit) may include a q-axis current limit value.

In parallel operation of the first motor 1500 and the second motor 1600, the overcurrent phenomenon due to the parameter difference between the first motor 1500 and the second motor 1600 is already described above. The overcurrent may cause demagnetization of the motor, and may even damage the switching device (or switching module) in the inverter 1200. Hence, the controller 2000 may perform control to limit a motor drive current when the overcurrent occurs due to the parameter difference between the first motor 1500 and the second motor 1600. When a drive voltage is output from the inverter 1200 to the first motor 1500 and the second motor 1600 in the parallel operation of the first motor 1500 and the second motor 1600, the drive voltage is equally applied to the first motor 1500 and the second motor 1600. When first motor 1500 and the second motor 1600 bear the same load and the parameter difference between the first motor 1500 and the second motor 1600 is not big, currents flowing to the first motor 1500 and the second motor 1600 may have the same value or have values within a minimum error between them. However, when the parameter difference between the first motor 1500 and the second motor 1600 is big, the difference between values of currents flowing to the first motor 1500 and the second motor 1600 has at least the minimum error. In this case, a phenomenon occurs where at least one of the currents flowing to the first motor 1500 and the second motor 1600 exceeds a preset current limit value. When at least one of the currents flowing to the first motor 1500 and the second motor 1600 exceeds the preset current limit value, the motor(s) whose operation has been stopped due to the overcurrent may be driven to a certain range by recognizing the parameter difference between the first motor 1500 and the second motor 1600 and changing current limit values to prevent both the current to each motor and the output current of the inverter 1200 from exceeding the limit values.

For example, a limit value of a current flowing to each motor is set to 2.2 A and the current limit value of the inverter 1200 is set to 4.5 A on the assumption that the first motor 1500 and the second motor 1600 are the same, but when the parameter of the first motor 1500 exceeds an expected value and differs from the parameter of the second motor 1600 by at least a certain value and the current flowing to the first motor 1500 is 2.4 A that exceeds the limit value, the power conversion device 1000 may be bound to stop operation of the first motor 1500 in the traditional method because the first motor 1500 exceeds the current limit value, e.g., 2.2 A. As the operation of the first motor 1500 is stopped, the power conversion device 1000 may also be bound to stop operation of the second motor 1600 that is being operated in parallel.

However, in an embodiment of the disclosure, when the parameter of the first motor 1500 exceeds the expected value and differs from the corresponding parameter of the second motor 1600 by at least the certain value, and the current flowing to the first motor 1500 reaches 2.4 A that exceeds the limit value, the controller 2000 needs to change the current limit value of the first motor 1500 to, for example, 2.5 A, and adjust the current limit value of the second motor 1600 to below 2.0 A with consideration for the current limit value 4.5 A of the inverter 1200. As such, by dynamically changing the current limit values of the first motor 1500 and the second motor 1600 with consideration for the limit value of the inverter 1200, the inverter 1200 may be continued to operate with the dynamic changes of the respective current limit values of the first and second motors 1500 and 1600 without stopping operation of the inverter 1200 due to an overcurrent in the first motor 1500 that exceeds the current limit value. Even when the current limit value of the first motor 1500 is changed to 2.5 A in the previous case, the current limit value of the first motor 1500 needs to be set to a smaller value than a demagnetization level current value of the first motor 1500. The demagnetization level current value may be stored in a memory of the power conversion device 1000 when the specification of the first motor 1500 is set. In an embodiment of the disclosure, as the current limit value of the second motor 1600 needs to be smaller than a demagnetization level current value of the second motor 1600 even when the current limit value of the second motor 1600 is larger than the current limit value of the first motor 1500, the demagnetization level current value of the second motor 1600 also needs to be stored in the memory of the power conversion device in advance.

In an embodiment of the disclosure, the heterogeneous control by the controller 2000 is performed by controlling the inverter 1200 such that at least one of the drive current of the first motor 1500 and the drive current of the second motor 1600 is equal to or smaller than a certain limit value based on the parameter of each motor. When the controller 2000 limits the drive current of each of the first motor 1500 and the second motor 1600 to be equal to or smaller than the certain limit value, the q-axis current and the d-axis current of a motor whose drive current is to be limited may be limited separately by a q-axis current limiter 2011 and a d-axis current limiter 2012, respectively.

The power conversion device 1000 may change one of the limit value of the drive current of the first motor 1500 and the limit value of the drive current of the second motor 1600 to be larger based on the parameter difference between the first motor 1500 and the second motor 1600. In this case, the drive current limit value of the other motor may be changed to be smaller than the original current limit value by consideration of the overall limit value of the inverter 1200. For example, when, among the parameters, a resistance value of the first motor 1500 is smaller than a resistance value of the second motor 1600, the drive current limit value of the first motor 1500 may be changed to be larger.

Hence, the controller 2000 may control the inverter 1200 by differently setting the limit value of the drive current of the first motor 1500 and the limit value of the drive current of the second motor 1600 based on the detected parameter of the first motor 1500 and the second motor 1600 to drive the first motor 1500 and the second motor 1600.

In an embodiment, when the loads of the first and second motors 1500 and 1600 are different, when the loads of the motors are the same but due to a parameter difference between the first and second motors 1500 and 1600, or when the loads of the first motor 1500 and the second motor 1600 are different and the parameters of the first motor 1500 and the second motor 1600 are also different, rotational speed of the first motor 1500 may differ from rotational speed of the second motor 1600. In this case, the controller 2000 may generate a compensation current command based on the parameter difference and/or the load difference between the first motor 1500 and the second motor 1600. The compensation current command is made to focus on the d-axis current compensator 2812. When there is a difference between the rotational speed ω1 of the first motor 1500 and the rotational speed ω2 of the second motor 1600, the controller 2000 may compensate a current command Id1* to equalize the rotational speeds of the first motor 1500 and the second motor 1600 by eliminating the difference.

A method of compensating the d-axis current command will now be described in detail with reference to FIGS. 5B to 5I.

FIG. 5B is a diagram illustrating d-q axis current and voltage when loads and parameters of first and second motors correspond to each other, according to an embodiment of the disclosure.

Referring to FIG. 5B, when the loads and parameters of the first and second motors 1500 and 1600 correspond to each other, d1 axis and q1 axis of the first motor 1500 corresponds to d2 axis and q2 axis of the second motor 1600. Axes on which the d1 axis and q1 axis of the first motor 1500 and the d2 axis and q2 axis of the second motor 1600 correspond to each other is denoted by d0 axis and q0 axis. Furthermore, when the load of the first motor 1500 and the load of the second motor 1600 are the same, the controller 2000 may control the d-q axis current I0 in a direction corresponding to the q0 axis to be applied to the first motor 1500 and the second motor 1600 as shown in FIG. 5B. In other words, the controller 2000 may control ‘0’ of the d0 axis current and ‘I0q0’ of the q0 axis current to flow to the first and second motors 1500 and 1600.

A d-q axis voltage to be applied to the first and second motors 1500 and 1600 so that the d-q axis current I0 is applied to the first motor 1500 and the second motor 1600 will now be described.

First, counter electromotive force E0 from rotational speed or of the rotor of the motor and magnetic flux λ_{f} of the rotor occurs in the corresponding direction to the q0 axis, and a voltage drop ωᵣ*Ls*I0 due to the coil of the stator occurs in a direction perpendicular to the d-q axis current I0. That is, the voltage drop ωᵣ*Ls*I0 due to the coil wound on the stator occurs in a direction of the d0 axis.

In order for the d-q axis current I0 to be applied to the first and second motors 1500 and 1600, the d-q axis voltage V0 corresponding to a vector sum of the voltage drop ωᵣ*Ls*I0 due to the coil of the stator of the motor and the counter electromotive force E0 needs to be applied to the first and second motors 1500 and 1600. In FIG. 5B, V0 is a sum of a d axis voltage V0d0 and a q0 axis voltage V0q0 in the vector space.

In summary, when the loads and parameters of the first and second motors 1500 and 1600 are the same, the controller 2000 controls the inverter 200 to apply the d0 axis voltage V0d0 and the q0 axis voltage V0q0 to the first and second motors 1500 and 1600 as shown in FIG. 5B. As a result, ‘O’ of the d0 axis current and ‘I0q0’ of the q0 axis current are applied to the first and second motors 1500 and 1600.

As such, when the loads and parameters of the first and second motors 1500 and 1600 are the same, the d1-q1 axis of the first motor 100 and the d2-q2 axis of the second motor 1600 correspond to each other, so the controller 2000 may control the first and second motors 1500 and 1600 based on the drive current and rotational speed of the first motor 1500. Specifically, the controller 2000 performs d-q conversion on the a, b, and c phase currents applied to the first motor 1500, and generates d-q axis current commands id1* and iq1* to be applied to the first motor 1500 based on the converted d-q axis current and rotational speed of the first motor 1500. The d-axis current command Id1* is converted to a current command Id1** limited by the d-axis current limiter 2012, and the q-axis current command Iq1* is converted to a current command Iq1** limited by the q-axis current limiter 2011. Subsequently, the controller 2000 applies the d-q axis limited current commands as inputs to the d-axis current controller 2002 and the q-axis current controller 2001, and finally, generates d-q axis voltage commands Vd1* and Vq1* to be applied to the first motor 1500. The d-q axis voltage commands Vd1* and Vq1* are converted to a, b and c phase voltage command Vabc* by the output coordinate converter 2050, and a PWM signal Vpwm to be applied to the inverter 1200 is output by the PWM signal generator 2060 to drive the first and second motors 1500 and 1600.

As the load of the first motor 1500 and the load of the second motor 1600 are the same and parameters of the first motor 1500 and the second motor 1600 are the same, the a, b and c phase current applied to the first motor 1500 is equal to the a, b and c phase current applied to the second motor 1600.

In an embodiment of the disclosure, when the load of the first motor 1500 and the load of the second motor 1600 are different from each other or parameters of the first and second motors 1500 and 1600 are different due to disturbance or other factors, the rotational speed of the first motor 1500 differs from the rotational speed of the second motor 1600 and the rotor position θ1 of the first motor 1500 differs from the rotor position θ2 of the second motor 1600. As a result, the d1 axis and q1 axis of the first motor 1500 and the d2 axis and q2 axis of the second motor 1600 differ from each other.

FIG. 5C illustrates d-q axis voltages applied to the first and second motors 1500 and 1600 when the rotational speeds of the first and second motors 1500 and 1600 are different from each other, according to an embodiment of the disclosure.

Referring to FIG. 5C, when the loads of the first and second motors 1500 and 1600 are different from each other and/or parameters of the first motor 1500 and the second motor 1600 are different, the d1 axis and q1 axis of the first motor 1500 and the d2 axis and q2 axis of the second motor 1600 deviate from each other.

As a result of the deviation between the d1 axis and q1 axis of the first motor 1500 and the d2 axis and q2 axis of the second motor 1600, when the d-q axis voltage V0 is applied to the first and second motors 1500 and 1600 as in FIG. 5B, the d1 axis voltage Vod1 and the q1 axis voltage V0q1 are applied to the first motor 1500 while the d2 axis voltage V0d2 and the q2 axis voltage V0q2 are applied to the second motor 1600. As such, as the d1 axis voltage and the q1 axis voltage applied to the first motor 1500 are different from the d2 axis voltage and the q2 axis voltage applied to the second motor 1600, the first drive current Iabc1 applied to the first motor 1500 is different from the second drive current Iabc2 applied to the second motor 1600. In other words, when the loads of the first and second motors 1500 and 1600 are different from each other and/or parameters of the first motor 1500 and the second motor 1600 are different, the second motor 1600 may no longer be controlled based on the drive current and rotational speed of the first motor 1500.

As such, when the loads of the first and second motors 1500 and 1600 are different from each other and/or parameters of the first motor 1500 and the second motor 1600 are different, the controller 2000 may change the d1 axis current Id1 of the first motor 1500 to alter output torque of the second motor 1600 without altering output torque of the first motor 1500. Furthermore, to change the d1-axis current, the controller 2000 may change the q1-axis voltage Vq1.

According to equation 3, as the output torque Te of the motor depends on the q-axis current Iqk of the motor and the d-axis voltage Vdk of the motor, changes in the d1 axis current Id1 and q1 axis voltage Vq1 of the first motor 1500 have no influence on the output torque of the first motor 1500.

As such, the controller 2000 may fix the q1-axis current and the d1-axis voltage of the first motor 1500 to be constant to keep the output torque of the first motor 1500 constant, and change the d1-axis current and the q1-axis voltage of the first motor 1500 to change the output torque of the second motor 1600.

As the d1 axis and q1 axis of the first motor 1500 deviate from the d2 axis and the q2 axis of the second motor 1600, when there is a change in d1-axis current of the first motor 1500, not only the d2 axis current but also the q2 axis current of the second motor 1600 change, and the output torque of the second motor 1600 changes due to the change in q2-axis current. Accordingly, the output torque of the second motor 1600 may be changed by changing the d1-axis current and the q1-axis voltage of the first motor 1500.

Furthermore, the controller 2000 may receive feedback of the rotational speed of the second motor 1600, and control the d1-axis current of the first motor 1500 such that a difference in rotational speed between the first and second motors 1500 and 1600 becomes zero.

FIGS. 5D to 5F illustrate an example of increasing the d1-axis current of the first motor 1500, according to an embodiment of the disclosure.

In FIG. 5D, the controller 2000 may control a d-q axis current I1 to be applied to the first motor 1500 by increasing the d1-axis current by adding Ild1 to the initial d-q axis current I0. For this, the controller 2000 may control the inverter 1200 so that the d-q axis voltage V1 corresponding to the vector sum of the counter electromotive force E0 and the voltage drop ωᵣ*Ls*I0 due to the coil is applied to the first and second motors 1500 and 1600. In other words, the controller 2000 may control the inverter 1200 so that the d1-axis voltage V0d1 (=V1d1) and the q1-axis voltage V0q1+ωᵣ*Ls*I1d1(=V1q1) are applied to the first and second motors 1500 and 1600.

When the loads and/or parameters of the first and second motors 1500 and 1600 are different, leading to a difference in rotational speed between the first and second motors 1500 and 1600, the d1 axis and q1 axis of the first motor 1500 and the d2 axis and q2 axis of the second motor 1600 may differ by −Δθ or +Δθ as shown in FIGS. 5E and 5F.

In an embodiment, when the d1 axis and q1 axis of the first motor 1500 and the d2 axis and q2 axis of the second motor 1600 differ by −Δθ, the d2-axis voltage applied to the second motor 1600 increases from V0d2 to V1d2 and the q-axis voltage increases from V0q2 to V1q2 as shown in FIG. 5E with the change of the d-q axis voltage applied to the second motor 1600 from V0 to V1. Furthermore, as the d2-axis voltage of the second motor 1600 increases, the q2-axis current increases, and output torque of the second motor 1600 increases due to the increase of the q2-axis current. Hence, in a case that the d1 axis and q1 axis of the first motor 1500 are ahead of the d2 axis and q2 axis of the second motor 1600 in the rotational direction, when the d1-axis current of the first motor 1500 increases, the output torque of the second motor 1600 may increase.

In an embodiment, when the d1 axis and q1 axis of the first motor 1500 and the d2 axis and q2 axis of the second motor 1600 differ by +Δθ, the d2-axis voltage applied to the second motor 1600 decreases from V0d2′ to V1d2′ and the q-axis voltage increases from V0q2′ to V1q2′ as shown in FIG. 5F with the change of the d-q axis voltage applied to the second motor 1600 from V0 to V1. Furthermore, as the d2-axis voltage of the second motor 1600 decreases, the q2-axis current decreases, and output torque of the second motor 1600 decreases due to the decrease of the q2-axis current. Hence, in a case that the d1 axis and q1 axis of the first motor 1500 fall behind the d2 axis and q2 axis of the second motor 1600 in the rotational direction, when the d1-axis current of the first motor 1500 increases, the output torque of the second motor 1600 may decrease.

FIGS. 5G to 5I illustrate an example of decreasing d1-axis current of a first motor, according to an embodiment of the disclosure.

As shown in FIG. 5G, the controller 2000 may control the inverter 1200 to apply a d-q axis current I2 to the first motor 1500 by adding the negative d1-axis current I2d2 to the initial d-q axis current I0. For this, the controller 2000 may control the inverter 1200 so that the d-q axis voltage V2 corresponding to the vector sum of the counter electromotive force E0 and the voltage drop ωᵣ*Ls*I0 due to the coil is applied to the first and second motors 1500 and 1600. In other words, the controller 2000 may control the inverter 1200 so that the d1-axis voltage V0d1 (=V2d1) and the q1-axis voltage V0q1+ωᵣ*Ls*I2d1(=V2q1) are applied to the first and second motors 1500 and 1600.

When the loads and/or parameters of the first and second motors 1500 and 1600 are different, leading to a difference in rotational speed between the first and second motors 1500 and 1600, the d1 axis and q1 axis of the first motor 1500 and the d2 axis and q2 axis of the second motor 1600 may differ by −Δθ or +Δθ as shown in FIGS. 5H and 5I.

In an embodiment, when the d1 axis and q1 axis of the first motor 1500 and the d2 axis and q2 axis of the second motor 1600 differ by −Δθ, the d2-axis voltage applied to the second motor 1600 decreases from V0d2 to V2d2 and the q-axis voltage decreases from V0q2 to V2q2 as shown in FIG. 5H with the change of the d-q axis voltage applied to the second motor 1600 from V0 to V2. Furthermore, as the d2-axis voltage of the second motor 1600 decreases, the q2-axis current decreases, and output torque of the second motor 1600 decreases due to the decrease of the q2-axis current. Hence, in a case that the d1 axis and q1 axis of the first motor 1500 are ahead of the d2 axis and q2 axis of the second motor 1600 in the rotation direction, when the d1-axis current of the first motor 1500 decreases, the output torque of the second motor 1600 may decrease.

In an embodiment, when the d1 axis and q1 axis of the first motor 1500 and the d2 axis and q2 axis of the second motor 1600 differ by +Δθ, the d2-axis voltage applied to the second motor 1600 increases from V0d2′ to V2d2′ and the q-axis voltage decreases from V0q2′ to V2q2′ as shown in FIG. 51 with the change of the d-q axis voltage applied to the second motor 1600 from V0 to V2. Furthermore, as the d2-axis voltage of the second motor 1600 increases, the q2-axis current increases, and output torque of the second motor 1600 increases due to the increase of the q2-axis current. Hence, in a case that the d1 axis and q1 axis of the first motor 1500 fall behind the d2 axis and q2 axis of the second motor 1600 in the rotation direction, when the d1-axis current of the first motor 1500 decreases, the output torque of the second motor 1600 may increase.

In conclusion, when there is a difference in rotational speed between the first and second motors 1500 and 1600, the controller 2000 may increase or decrease output torque of the second motor 1600 by increasing or decreasing the d1-axis current of the first motor 1500 depending on the rotor positions of the first and second motors 1500 and 1600. In other words, when the rotational speed of the second motor 1600 is higher than the rotational speed of the first motor 1500 due to a difference in load or parameter, the controller 2000 may decrease the d1-axis current of the first motor 1500 to reduce the output torque of the second motor 1600. Furthermore, when the rotational speed of the second motor 1600 is lower than the rotational speed of the first motor, the controller 2000 may change the d1-axis current of the first motor 1500 to increase the output torque of the second motor.

Although the method of changing the d1-axis current is described above by assuming the first motor 1500 as a master, the second motor 1600 may be designated as a master and in this case, the d2-axis current may be controlled in the same method as described above to equalize the rotational speeds of the first motor 1500 and the second motor 1600.

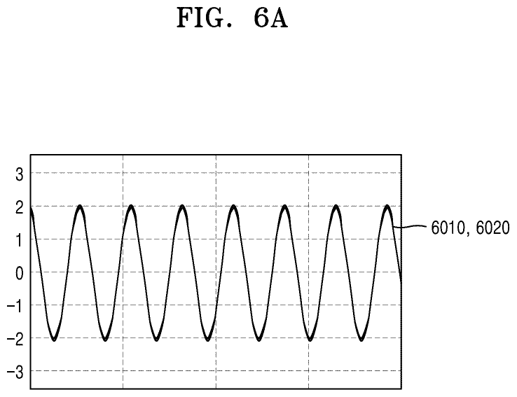

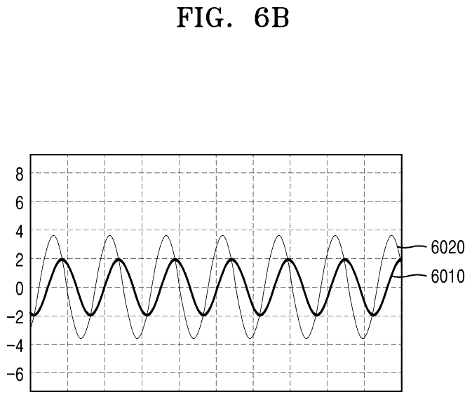

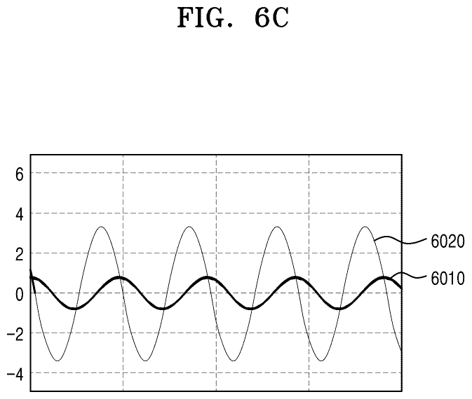

FIGS. 6A, 6B and 6C are current waveform diagrams when first motor 1500 and the second motor 1600 are driven by limiting motor drive currents for heterogeneous control, according to an embodiment of the disclosure.

Referring to FIG. 6A, shown are a first drive current 6010 flowing to the first motor 1500 and a second drive current 6020 flowing to the second motor 1600. As shown in FIG. 6A, when the parameters of the first and second motors 1500 and 1600 are all the same, the first drive current 6010 and the second drive current 6020 flowing to the respective motors have the same magnitude and phase during the parallel operation. In FIG. 6A, a peak value of the current flowing to each motor is 2 A. Throughout FIGS. 6A to 6C, it is assumed that a current limit value of the inverter 1200 that drives the first motor 1500 and the second motor 1600 in parallel is 4 A. In FIG. 6A, limit values of drive currents flowing to the first motor 1500 and the second motor 1600 are 2 A each.

FIG. 6B illustrates waveforms of drive currents flowing to the respective motors when the counter electromotive force of the first motor 1500 is about 16% smaller than that of the second motor 1600. In FIG. 6B, there is a difference in parameter between the first and second motors 1500 and 1600, and with the parameter difference, the second drive current 6020 flowing to the second motor 1600 is larger than the first drive current 6010 flowing to the first motor 1500. As the peak value of the second drive current 6020 is about 3 A, there is a section where a sum of the first drive current 6010 and the second drive current 6020 exceeds 4 A even with a slight phase difference of the second drive current 6020 from the first drive current 6010. Accordingly, it happens that the drive current of the inverter 1200, which is the sum of the first and second drive currents 6010 and 6020, exceeds the current limit value 4 A, and thus, the power conversion device 1000 is bound to stop operation.

FIG. 6C shows waveforms of drive currents when the limit values of the drive currents flowing to the motors are differently set based on the parameter difference, according to an embodiment of the disclosure.

In FIG. 6C, even when the currents flowing to the first motor 1500 and the second motor 1600 are different due to a difference in parameter (counter electromotive force), the respective current limit values are dynamically set, thereby preventing operation halt of the power conversion device 1000. In an embodiment, the drive current limit values for the first drive current 6010 and the second drive current 6020 are differently set to avoid having a section where a sum of the first drive current 6010 and the second drive current 6020 exceeds 4 A, thereby preventing the operation halt. To avoid having the section where 4 A of the current limit value of the inverter 1200 is exceeded as in FIG. 6B, the current limit value of the first drive current 6010 is set to be a bit lower than the existing 2 A in FIG. 6C so that a sum of the first drive current 6010 and the second drive current 6020 does not exceed the current limit value of the inverter 1200.

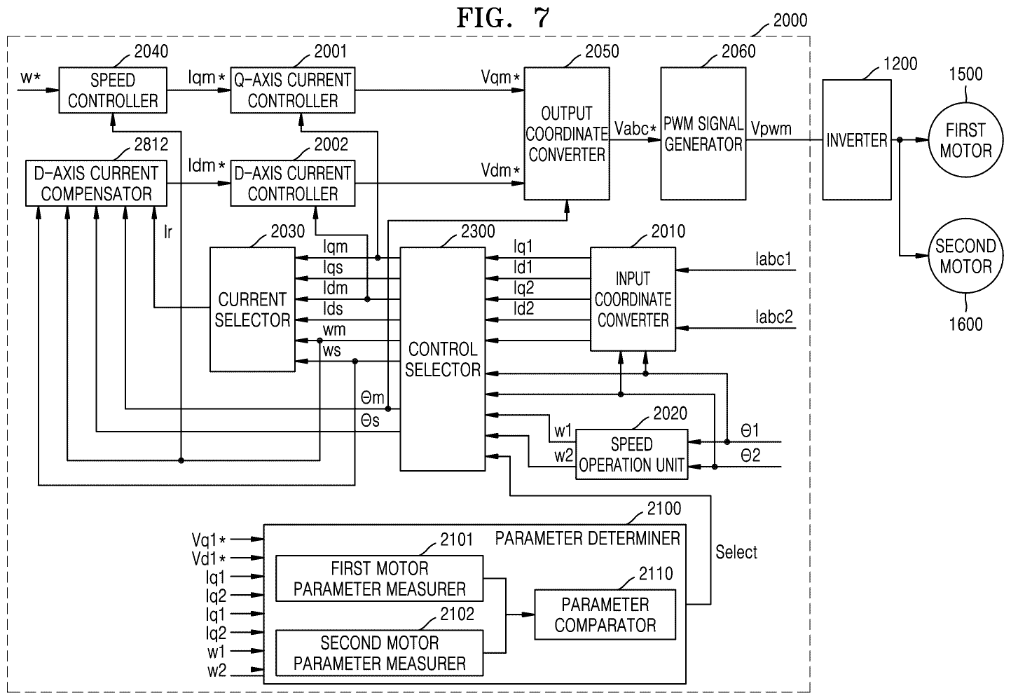

FIG. 7 is a block diagram of a configuration for selecting a master to be controlled for heterogeneous control, according to an embodiment of the disclosure.

The power conversion device 1000 designates and controls, by the controller 2000, one of the first and second motors 1500 and 1600 as a master. It is desirable to designate and control a motor with larger torque as a master among the first motor 1500 and the second motor 1600.

When the first and second motors 1500 and 1600 have the same parameters, the controller 2000 receives current values iq1, id1, iq2 and id2 of the first motor 1500 and the second motor 1600 as inputs to distinguish a motor with a heavier load from among the first motor 1500 and the second motor 1600, and designates and controls the motor as a master and the other as a slave. On the other hand, when there is a parameter difference between the first motor 1500 and the second motor 1600, a control selector 2300 of the controller 2000 receives, as inputs, not only the current values iq1, id1, iq2 and id2 of the first motor 1500 and the second motor 1600 for comparing and distinguishing sizes of loads of the first motor 1500 and the second motor 1600 but also a determined value Select from the parameter comparator 2110 for consideration of the parameter difference between the first motor 1500 and the second motor 1600.

The control selector 2300 finally designates a master by considering not only the load sizes of the first motor 1500 and the second motor 1600 but also the parameter difference between the first motor 1500 and the second motor 1600. In this case, a method of selecting a d-q axis current to minimize the loss will be found when there is a difference in parameter.

As the first and second motors 1500 and 1600 are connected in parallel, the same drive voltage is applied to the first and second motors 1500 and 1600. Using this, equation 5 may be derived from equation 2:

$${V}^{2} = Vd {1}^{2} + Vq {1}^{2} = Vd {2}^{2} + Vq {2}^{2} = {( {R}_{S} Id 1 - {ω}_{r} {L}_{S} Iq 1 )}^{2} + [ {R}_{S} Iq 1 + {ω}_{r} ( {λ}_{f} + {{L}_{S} Id 1 ) ]}^{2} = {( {R}_{S} Id 2 - {ω}_{r} {L}_{S} Iq 2 )}^{2} + {[ {R}_{S} Iq 2 + {ω}_{r} ( {λ}_{f} + {L}_{S} Id 2 ) ]}^{2} \qquad ( Equation 5 )$$

(where, V², Vd1², Vq1², Vd2², Vq2² are the square of V, Vd1, Vq1, Vd2, and Vq2, V is the d-q voltage applied to the first and second motors 1500 and 1600, Vd1 is the d-axis voltage of the first motor 1500, Vq1 is the q-axis voltage of the first motor 1500, Vd2 is the d-axis voltage of the second motor 1600, Vq2 is the q-axis voltage of the second motor 1600, Rs is resistance of a coil included on the stator, Ls is inductance of the coil included on the stator, λ_{f} is magnetic flux of a permanent magnet included in the rotor, or is the rotational speed of the rotor, Id1 is the d-axis current of the first motor 1500, Iq1 is the q-axis current of the first motor 1500, Id2 is the d-axis current of the second motor 1600, and Iq2 is the q-axis current of the second motor 1600.)

In equation 5, it is difficult to change the q-axis current Iq1 of the first motor 1500 and the q-axis current Ia2 of the second motor 1600 to produce an output torque corresponding to the load. On the other hand, the d-axis current Id1 of the first motor 1500 and the d-axis current Id2 of the second motor 1600 may be changeable within a range that allows the first and second motors 1500 and 1600 to have the same rotational speed. A relation between Id1 and Id2 is expressed as in equation 6 by summing up equation 5.

$${[ {I}_{d 1} + \frac{β}{2 α} ]}^{2} - {[ {I}_{d 2} + \frac{β}{2 α} ]}^{2} = \frac{{γ}_{2} - {γ}_{1}}{α} \qquad ( Equation 6 )$$

$$( α = {R}_{S}^{2} + {ω}_{r}^{2} {L}_{S}^{2} , β = 2 {ω}_{r}^{2} {λ}_{f} {L}_{S} , {γ}_{1} = ( {R}_{S}^{2} + {ω}_{r}^{2} {L}_{S}^{2} ) {I}_{q 1}^{2} + 2 {R}_{S} {ω}_{r} {λ}_{f} {I}_{q 1} + {ω}_{r}^{2} {λ}_{r}^{2} , {γ}_{2} = ( {R}_{S}^{2} + {ω}_{r}^{2} {L}_{S}^{2} ) {I}_{q 2}^{2} + 2 {R}_{S} {ω}_{r} {λ}_{f} {I}_{q 2} + {ω}_{r}^{2} {λ}_{f}^{2} )$$

In other words, when the first and second motors 1500 and 1600 are connected in parallel and have the same rotational speed, Id1 and Id2 have a relation as in equation 6.

In this case, the loss of the first and second motors 1500 and 1600 is as in equation 7:

$$P ( loss ) = 3 / 2 * Rs ( Id {1}^{2} + Iq {1}^{2} + Id {2}^{2} + Iq {2}^{2} ) \qquad ( Equation 7 )$$

(where P(loss) is a conduction loss of the first and second motors 1500 and 1600.)

As described above, it is difficult to change the q-axis current Iq1 of the first motor 1500 and the q-axis current Iq2 of the second motor 1600 to produce a load-dependent output torque, so (Id1²+Id2²) needs to be minimized to minimize the loss of the first and second motors 1500 and 1600.

According to equation 6, Id1 and Id2 have a hyperbolic relation. In this case, when a circle from (Id1²+Id2²) is tangent to a hyperbola from equation 6, (Id1²+Id2²) may be minimized. When (Id1²+Id2²) is minimized, Id1 and Id2 have a relation as in the following equation 8:

$$\frac{1}{{I}_{d 1}} + \frac{1}{{I}_{d 2}} = \frac{4 α}{β} ( α = {R}_{S}^{2} + {ω}_{r}^{2} {L}_{S}^{2} , β = 2 {ω}_{r}^{2} {λ}_{f} {L}_{S} ) \qquad ( Equation 8 )$$

The relation between Id1 and Id2 of equation 8 shows determining Id1 and Id2 values that minimize P(loss) by assuming that the motor parameters such as Rs, Ls, λ_{f}, etc., are the same. When there is a parameter difference between the first motor 1500 and the second motor 1600, a motor that may be controlled to minimize P(loss) is designated as a master in an embodiment of the disclosure. For example, when P(loss) is reduced when the second motor 1600 is designated as a master in calculating a current that minimizes the loss with consideration for the parameter although a load of the first motor 1500 is heavier than the load of the second motor 1600, the control selector 2300 designates the second motor 1600 as the master.

For example, when there is a difference in stator resistance between the first and second motors 1500 and 1600, equation 5 may be modified to the following equation 9:

$${V}^{2} = Vd {1}^{2} + Vq {1}^{2} = Vd {2}^{2} + Vq {2}^{2} = {( {R}_{S 1} Id 1 - {ω}_{r} {L}_{S} Iq 1 )}^{2} + [ \text{} {R}_{S 1} Iq 1 + {ω}_{r} ( {λ}_{f} + {{L}_{S} Id 1 ) ]}^{2} = {( {R}_{S 2} Id 2 - {ω}_{r} {L}_{S} Iq 2 )}^{2} + {[ {R}_{S 2} Iq 2 + {ω}_{r} ( {λ}_{f} + {L}_{S} Id 2 ) ]}^{2} ( , {R}_{s 1} \neq {R}_{s 2} ) \qquad ( Equation 9 )$$

Although it is assumed in equation 9 that there is a difference in stator resistance between the first and second motors 1500 and 1600, an occasion when there is a difference in inductance Ls of a coil included on the stator or magnetic flux λ_{f} of a permanent magnet in the rotor between the first and second motors 1500 and 1600 may be represented by the following Equations 10 and 11:

$${V}^{2} = Vd {1}^{2} + Vq {1}^{2} = Vd {2}^{2} + Vq {2}^{2} = {( {R}_{S} Id 1 - {ω}_{r} {L}_{S 1} Iq 1 )}^{2} + [ \text{} {R}_{S} Iq 1 + {ω}_{r} ( {λ}_{f} + {{L}_{S 1} Id 1 ) ]}^{2} = {( {R}_{S} Id 2 - {ω}_{r} {L}_{S 2} Iq 2 )}^{2} + {[ {R}_{S} Iq 2 + {ω}_{r} ( {λ}_{f} + {L}_{S 2} Id 2 ) ]}^{2} ( , {L}_{S 1} \neq {L}_{S 2} ) \qquad ( Equation 10 )$$

$${V}^{2} = Vd {1}^{2} + Vq {1}^{2} = Vd {2}^{2} + Vq {2}^{2} = {( {R}_{S} Id 1 - {ω}_{r} {L}_{S} Iq 1 )}^{2} + [ \text{} {R}_{S} Iq 1 + {ω}_{r} ( {λ}_{f 1} + {{L}_{S} Id 1 ) ]}^{2} = {( {R}_{S} Id 2 - {ω}_{r} {L}_{S} Iq 2 )}^{2} + {[ {R}_{S} Iq 2 + {ω}_{r} ( {λ}_{f 2} + {L}_{s} Id 2 ) ]}^{2} ( , {λ}_{f 1} \neq {λ}_{f 2} ) \qquad ( Equation 11 )$$

This is merely an example, but an occasion when at least two or all of the stator resistance Rs, the stator's coil inductance Ls or magnetic flux λ_{f} of the permanent magnet in the rotor between the first motor 1500 and the second motor 1600 are different from each other may also be considered, and the occasion when there are differences in all the three parameters is represented in equation 12.

$${V}^{2} = Vd {1}^{2} + Vq {1}^{2} = Vd {2}^{2} + Vq {2}^{2} = {( {R}_{S 1} Id 1 - {ω}_{r} {L}_{S 1} Iq 1 )}^{2} + [ \text{} {R}_{S 1} Iq 1 + {ω}_{r} ( {λ}_{f 1} + {{L}_{S 1} Id 1 ) ]}^{2} = {( {R}_{S} Id 2 - {ω}_{r} {L}_{S 2} Iq 2 )}^{2} + {[ {R}_{S 2} Iq 2 + {ω}_{r} ( {λ}_{f 2} + {L}_{S 2} Id 2 ) ]}^{2} ( , {R}_{s 1} \neq {R}_{s 2} , {L}_{S 1} \neq {L}_{S 2} , {λ}_{f 1} \neq {λ}_{f 2} ) \qquad ( Equation 12 )$$

Equations related to voltages applied when there is a difference in parameter between the first motor 1500 and the second motor 1600 correspond to equations 9 to 12, and an optimal control point where the conduction loss is minimized may be found according to equations 6 to 8.

In an embodiment, the control selector 2300 may select a master to be controlled based only on the parameter difference between the first motor 1500 and the second motor 1600 without consideration for loads of the first motor 1500 and the second motor 1600. When a larger current flows to the first motor 1500 than to the second motor 1600 based on the parameter difference between the first motor 1500 and the second motor 1600 while assuming the same load, the first motor 1500 is selected as the master to be controlled. In other words, a motor to which a larger current flows is designated as a master.

In an embodiment, when a larger current ends up flowing to the second motor 1600 because the counter electromotive force of the first motor 1500 is smaller than the counter electromotive force of the second motor 160 although the first motor 1500 has a heavier load than the load of the second motor 1600, the control selector 2300 designates the second motor 1600 as a master.

For the parameter difference, electromotive force is taken above as an example, but the method will be equally applied to an occasion when levels of currents flowing to the first motor 1500 and the second motor 1600 differ due to a difference in resistance or inductance as a parameter.

Based on the selection of a master to be controlled, the control selector 2300 applies master control current commands Iqm* and Idm* as inputs to the q-axis current controller 2001 and the d-axis current controller 2002, respectively, and as outputs of the q-axis current controller 2001 and the d-axis current controller 2002, master control voltage commands Vqm* and Vdm* are generated and finally applied to the PWM signal generator 2060 as voltage command inputs through the output coordinate converter 2050.

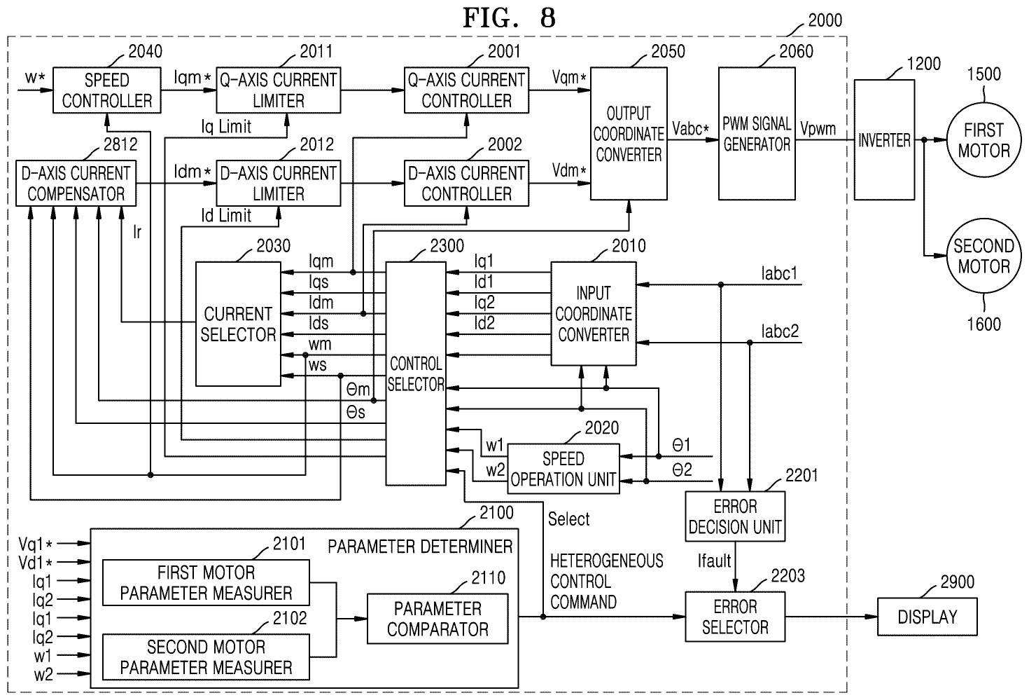

FIG. 8 is a block diagram of a power conversion device for performing heterogeneous control, according to an embodiment of the disclosure.

Referring to FIG. 8, the controller 2000 of the power conversion device 1000 includes all the following functions: a parameter comparison function through the parameter determiner 2100, an error display (heterogeneous display due to a parameter difference between first motor 1500 and the second motor 1600) function through the error decision unit 2201, the error selector 2203 and the display 2900, a current limit function through the q-axis current limiter 2011 and the d-axis current limiter 2012, and the function of the control selector 2300 for selecting a master to be controlled from among the motors with consideration for a parameter difference and/or a load current difference. Each of the functions is described in detail with reference to FIGS. 3, 4, 5 and 7, so the descriptions will not be repeated. Each function may be added or omitted by the designer of the power conversion device 1000 as required.

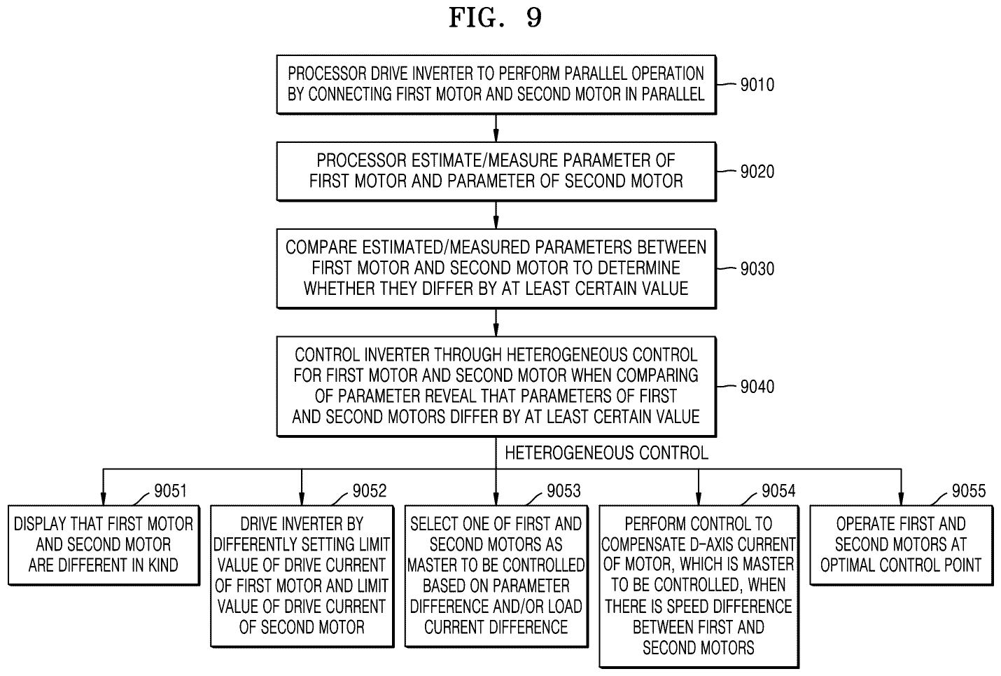

FIG. 9 is a flowchart for performing heterogeneous control when a plurality of motors differ in parameter, according to an embodiment of the disclosure.

In operation 9010, the processor of the power conversion device 1000 operates the inverter 1200 to perform parallel operation on the first and second motors 1500 and 1600 connected in parallel.

In operation 9020, the processor of the power conversion device 1000 determines a parameter of the first motor 1500 and a parameter of the second motor 1600 by estimation/measurement. The motor parameter estimation/measurement method is described above with reference to FIG. 3, so the description will not be repeated. The parameter may include the motor's resistance, inductance and counter electromotive force, without being limited thereto. For example, the motor's leakage inductance may also be included in the parameter.

In operation 9030, the processor of the power conversion device 1000 compares the estimated (measured) parameters of the first and second motors 1500 and 1600 and determines whether the parameters differ by at least a certain value. The certain value may be an absolute value according to the specification of the motor or a percentage (%) value that compares the same kind of parameters between motors. For example, assuming that the motor resistors of the first and second motors 1500 and 1600 are produced with a mark of 2 Ω, 10% of 2Ω, i.e., 2.2Ω-2 Ω=0.2Ω, may correspond to the certain value.

In operation 9040, when it is determined from a result of the comparing of the parameters that the parameter of the first motor 1500 and the parameter of the second motor 1600 differ by at least the certain value, the processor of the power conversion device 1000 controls the inverter 1200 through heterogeneous control over the first and second motors 1500 and 1600.

The heterogeneous control due to the parameter difference between first motor 1500 and the second motor 1600 includes at least one of a function of displaying 9051 that the first and second motors 1500 and 1600 are heterogeneous kinds, a function of operating 9052 the inverter 1200 by differently setting the limit value of the drive current of the first motor 1500 and the limit value of the drive current of the second motor 1600 based on different parameters, a function of selecting 9053 one of the first and second motors 1500 and 1600 as a master to be controlled based on a parameter difference and/or a load current difference, a function of performing 9054 control to compensate the d-axis current of the motor that is the master to be controlled among the first and second motors 1500 and 1600 when there is a difference in speed between the first and second motors 1500 and 1600, and a function of driving 9055 the first and second motors 1500 and 1600 at an optimal control point when there is a parameter difference.

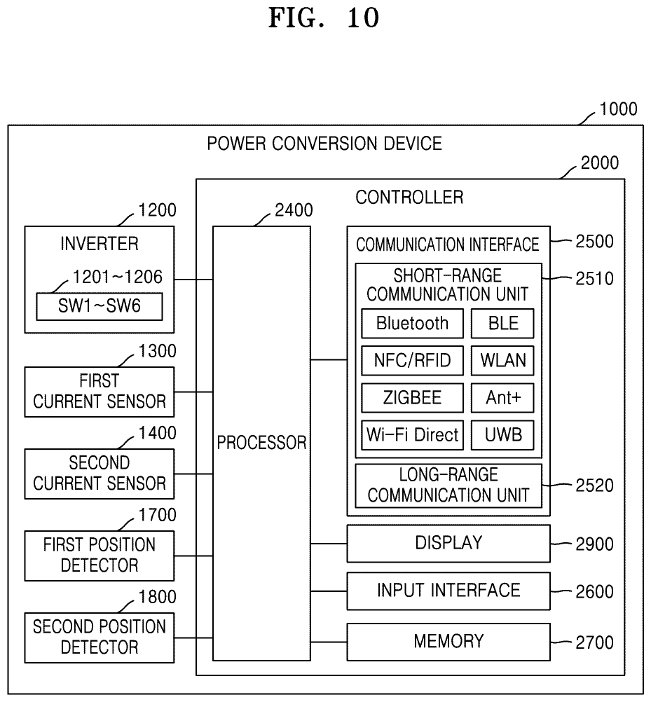

FIG. 10 is a block diagram of a power conversion device, according to an embodiment of the disclosure.

As shown in FIG. 10, in an embodiment of the disclosure, the power conversion device 1000 may include the inverter 1200 and the controller 2000. However, not all the illustrated components are essential. The power conversion device 1000 may be implemented with more or fewer components than illustrated ones. As shown in FIG. 10, in an embodiment of the disclosure, the power conversion device 1000 may include the first current sensor 1300, the second current sensor 1400, the first position detector 1700, the second position detector 1800, a communication interface 2500, an input interface 2600, a memory 2700 and the display 2900 in addition to the inverter 1200 and the controller 2000.

The aforementioned components will now be described in detail.

A detailed configuration and operation of the inverter 1200 is described above with reference to FIG. 2C, so the detailed description will not be repeated. The inverter includes switching devices SW1 1201, SW2 1202, SW3 1203, SW4 1204, SW5 1205 and SW6 1206 to convert a DC link voltage to an AC voltage with PWM signals. The first and second motors 1500 and 1600 connected in parallel are driven by the AC voltage produced by switching of the switching devices.

The controller 2000 controls general operation of the power conversion device 1000. The controller 2000 includes a processor 2400 for overall control over the power conversion device 1000. The processor 2400 may control the inverter 1200, the communication interface 2500, the display 2900, the input interface 2600 and the memory 2700 by executing programs stored in the memory 2700.

In an embodiment of the disclosure, the power conversion device 1000 may include an AI processor. The AI processor may be manufactured into the form of a dedicated hardware chip for AI, or manufactured as a portion of the existing universal processor (e.g., a CPU or an application processor) or a graphic-dedicated processor (e.g., a GPU) and mounted in the power conversion device 1000.

In an embodiment of the disclosure, the processor 2400 may perform the functions in the controller 2000 as shown in FIG. 8. Specifically, the processor 2400 may perform all the functions of the speed controller 2040, the q-axis current limiter 2011, the q-axis current controller 2001, the d-axis current limiter 2012, the d-axis current controller 2002, the d-axis current compensator 2812, the input coordinate converter 2010, the parameter determiner 2100, the first motor parameter measurer 2101, the second motor parameter measurer 2102, the parameter comparator 2110, the speed operation unit 2020, the error decision unit 2201, the error selector 2203, the control selector 2300, the current selector 2030, the output coordinate converter 2050 and the PWM signal generator 2060.

The processor 2400 may control the display 2900 to display a notification from the error selector 2203.

The first current sensor 1300 and the second current sensor 1400 detect drive currents of the first and second motors 1500 and 1600, respectively. In an embodiment, the first current sensor 1300 and the second current sensor 1400 may be current transformers (CTs) that measure the drive currents in real time with electric wires connected to the motors boring through them.

The first position detector 1700 and the second position detector 1800 are attached to the first motor 1500 and the second motor 1600, respectively, to detect a rotor position to be used in calculating the speed of the motor. The first position detector 1700 and the second position detector 1800 may be hall sensors, encoders or resolvers.

The communication interface 2500 may include at least one component that allows communication between the power conversion device 1000 and a server device (not shown) or between the power conversion device 1000 and a mobile device (not shown). For example, the communication interface 2500 may include a short-range communication unit 2510, a long-range communication unit 2520, etc.

The short-range communication unit 2510 may include a bluetooth communication unit, a bluetooth low energy (BLE) communication unit, a near field communication unit (NFC), a wireless local area network (WLAN), e.g., Wi-Fi, communication unit, a Zigbee communication unit, an infrared data association (IrDA) communication unit, a Wi-Fi direct (WFD) communication unit, an ultra wideband (UWB) communication unit, an Ant+ communication unit, etc., without being limited thereto. The long-range communication unit 2520 may be used to communicate with a server device (not shown) when the power conversion device 1000 is remotely controlled by the server device in an Internet of things (IoT) environment. The long-range communication unit 2520 may include the Internet, a computer network (e.g., a local area network (LAN) or wide area network (WAN)), or a mobile communication unit. The mobile communication unit may include a 3rd generation (3G) unit, a 4th generation (4G) unit, a 5th generation (5G) unit, a long term evolution (LTE) unit, a narrow band (NB) IoT unit, an LTE machine type communication (LTE-M) unit, etc., without being limited thereto.

The display 2900 is used to display required data.

In a case that the display 2900 and a touch pad form a layered structure to constitute a touch screen, the display 2900 may also be used as the input interface 2600. The display 2900 may include at least one of a liquid crystal display (LCD), a thin film transistor-liquid crystal display (TFT-LCD), light emitting diodes (LEDs), organic LEDs (OLEDs), a flexible display, a three-dimensional (3D) display, or an electrophoretic display. Furthermore, depending on the form of implementation of the power conversion device 1000, the power conversion device 1000 may include two or more displays 2900.

The input interface 2600 is for receiving inputs from the user. The input interface 2600 may be at least one of a key pad, a dome switch, a (capacitive, resistive, infrared detection type, surface acoustic wave type, integral strain gauge type, piezoelectric effect type) touch pad, a jog wheel or a jog switch, but is not limited thereto.

The input interface 2600 may include a voice recognition module. For example, the power conversion device 1000 may receive an analog voice signal through a microphone, and convert a voice part into computer-readable text by using an automatic speech recognition (ASR) model. The power conversion device 1000 may obtain the user's intention of talking by interpreting the text by using a natural language understanding (NLU) model. The ASR model or the NLU model may be an AI model. The AI model may be processed by an AI dedicated processor designed in a hardware structure specialized in processing the AI model. The AI model may be made by learning. Specifically, a predefined operation rule or an AI model being made by learning refers to the predefined operation rule or the AI model established to perform a desired feature (or an object) being made when a basic AI model is trained by a learning algorithm with a lot of training data. The AI model may include a plurality of neural network layers. Each of the plurality of neural network layers may have a plurality of weight values, and perform neural network operation through operation between an operation result of the previous layer and the plurality of weight values.

Linguistic understanding is a technology to recognize, and apply/process human languages/text, which includes natural language processing, machine translation, dialog system, question answering, speech recognition/synthesis, etc.

The memory 2700 may store a program for processing and controlling of the processor 2400 and also store input/output data (e.g., recipe information, area table, interval table, crop area size, crop area size information, distortion correction value, brightness level table, etc.). The memory 2700 may also store AI models. For example, the memory 2700 may store an AI model for object recognition, an AI model for recipe recommendation, etc.

The memory 2700 may include at least one type of storage medium including a flash memory, a hard disk, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable ROM (PROM), a magnetic memory, a magnetic disk, and an optical disk. Furthermore, the power conversion device 1000 may operate a web storage or a cloud server that performs a storage function on the Internet.

The method according to an embodiment of the disclosure may be implemented in program instructions which are executable by various computing means and recorded in computer-readable media. The computer-readable media may include program instructions, data files, data structures, etc., separately or in combination. The program instructions recorded on the computer-readable media may be designed and configured specially for the disclosure, or may be well-known to those of ordinary skill in the art of computer software. Examples of the computer readable recording medium include a magnetic medium such as a hard disk, a floppy disk and a magnetic tape, an optical medium such as a compact disc read-only memory (CD-ROM) and a digital versatile disc (DVD), a magneto-optical medium such as a floptical disk, and a hardware device specially configured to store and perform program instructions, such as a read-only memory (ROM), a random-access memory (RAM), a flash memory, etc. Examples of the program instructions include not only machine language codes but also high-level language codes which are executable by various computing means using an interpreter.

Some embodiments of the disclosure may be implemented in the form of a computer-readable recording medium that includes computer-executable instructions such as the program modules executed by the computer. The computer-readable medium may be an arbitrary available medium that may be accessed by the computer, including volatile, non-volatile, removable, and non-removable mediums. The computer-readable recording medium may also include a computer storage medium and a communication medium. The computer-readable medium includes all the volatile, non-volatile, removable, and non-removable mediums implemented by an arbitrary method or technology for storage of information, such as computer-readable instructions, data structures, program modules, or other data. The communication medium generally includes computer-readable instructions, data structures, program modules, or other data or other transmission mechanism for modulated data signals like carrier waves, and include arbitrary information delivery medium. Furthermore, some embodiments of the disclosure may be implemented in a computer program or a computer program product including computer-executable instructions.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a machine-readable storage medium (e.g., a CD-ROM) or distributed directly between two user devices (e.g., smart phones) or online (e.g., downloaded or uploaded). In the case of the online distribution, at least part of the computer program product (e.g., a downloadable app) may be at least temporarily stored or arbitrarily created in a storage medium that may be readable to a device such as a server of the manufacturer, a server of the application store, or a relay server.

1-20. (canceled)

21. An air conditioner comprising:
an inverter configured to drive a first motor for driving a first outdoor unit and a second motor for driving a second outdoor unit in parallel; and
a processor configured to:
determine parameters of the first motor and parameters of the second motor,
compare the parameters of the first motor with the parameters of the second motor to determine whether the parameters of the first motor and the parameters of the second motor differ by at least a certain value, and
control the inverter through heterogeneous control for the first motor and the second motor based on the parameters of the first motor and the parameters of the second motor differing by at least the certain value.

22. The air conditioner of claim 21, wherein the parameters of the first motor and the parameters of the second motor comprise at least one of each motor's resistance, inductance and counter electromotive force.

23. The air conditioner of claim 21, further comprising:
a display,
wherein the heterogeneous control is characterized in that the processor is configured to indicate on the display that the first motor and the second motor are different in kind.

24. The air conditioner of claim 21, further comprising:
current sensors detecting a current of the first motor and a current of the second motor,
wherein the heterogeneous control is characterized in that the processor is configured to determine by the processor, when a current detected by at least one of the current sensors is an overcurrent that exceeds a certain current value to be controlled by the inverter, that the overcurrent is caused by a difference of at least a certain value between the parameters of the first motor and the parameters of the second motor.

25. The air conditioner of claim 21, wherein the heterogeneous control is characterized in that the processor is configured to control the inverter by differently setting a limit value of a drive current of the first motor and a limit value of a drive current of the second motor based on the parameters of the first motor and the parameters of the second motor.

26. The air conditioner of claim 25, further comprising:
a display,
wherein the heterogeneous current is characterized by indicating on the display that the overcurrent is caused by a difference of at least a certain value between the parameters of the first motor and the parameters of the second motor.

27. The air conditioner of claim 21,
wherein the heterogeneous control is characterized in that the processor controls the inverter by differently setting a limit value of a drive current of the first motor and a limit value of a drive current of the second motor based on the parameters.

28. The air conditioner of claim 27, wherein the processor is configured to independently control a q-axis current and a d-axis current of at least one of the first motor and the second motor whose drive current is to be limited, in limiting the drive current of the first motor or the second motor to be equal to or smaller than the limit value of the drive current of the first motor or the limit value of the drive current of the second motor.

29. The air conditioner of claim 27, wherein the heterogeneous control is characterized in that the processor is configured to set a sum of the limit value of the drive current of the first motor and the limit value of the drive current of the second motor to be equal to or smaller than a limit value of a drive current of the inverter.

30. The air conditioner of claim 27, wherein the processor is configured to control the inverter so that a larger one of the limit value of the drive current of the first motor and the limit value of the drive current of the second motor is smaller than a demagnetization level current of the first motor or the second motor.

31. The air conditioner of claim 21, wherein the heterogeneous control is characterized in that the processor is configured to select one of the first motor and the second motor as a master to be controlled.

32. The air conditioner of claim 31, wherein the processor is configured to select a motor with greater torque from among the first motor and the second motor as the master to be controlled by consideration of a parameter difference between the first and second motors.

33. The air conditioner of claim 31, wherein the processor is configured to select a motor with a larger current flowing thereto from among the first motor and the second motor as the master to be controlled by consideration of a parameter difference between the first and second motors and loads of the first and second motors.

34. The air conditioner of claim 21, wherein the processor is configured to perform compensation control on a d-axis current of a motor which is a master to be controlled among the first and second motors when there is a speed difference between the first and second motors.

35. The air conditioner of claim 21, wherein,
when a parameter difference between the first motor and the second motor causes a difference between a torque of the first motor and a torque of the second motor and a speed difference between the first and second motors, a rotational speed of the second motor being higher than a rotational speed of the first motor, the processor is configured to compensate a d-axis current of the first motor to reduce the torque of the second motor.

36. The air conditioner of claim 21, wherein, when a parameter difference between the first motor and the second motor causes a difference between a torque of the first motor and a torque of the second motor and loads of the first and second motors differ from each other, the first and second motors are driven to minimize a conduction loss based on the parameter difference.

37. The air conditioner of claim 21, wherein, when a parameter difference between the first motor and the second motor causes a torque difference and a speed difference between the first and second motors, the rotational speed of the second motor being less than the rotation seed of the first motor, the processor is further configured to compensate a d-axis current of the first motor to increase the torque of the second motor.

38. The air conditioner of claim 37, wherein the difference in speed between the first and second motors is caused by a difference in parameters between the first and second motors and a difference in load between the first and second motors.

39. An air conditioner system comprising:
first and second outdoor units;
first and second motors;
an inverter configured to drive in parallel the first motor for driving the first outdoor unit and the second motor for driving the second outdoor unit; and
a processor configured to:
determine parameters of the first motor and parameters of the second motor,
compare the parameters of the first motor with the parameters of the second motor to determine whether the parameters of the first motor and the parameters of the second motor differ by at least a certain value, and
control the inverter through heterogeneous control for the first motor and the second motor based on the parameters of the first motor and the parameters of the second motor differing by at least the certain value.

40. A method of driving a plurality of motors in parallel in an air conditioner including an inverter, the plurality of motors having a difference in parameter and being used for operating outdoor units, the method comprising:
determining parameters of a first motor of the plurality of the motors for driving a first outdoor unit and parameters of a second motor of the plurality of the motors for driving a second outdoor unit;
comparing the parameters of the first motor with the parameters of the second motor to determine whether the parameters of the first motor and the parameters of the second motor differ by at least a certain value; and
controlling the inverter through heterogeneous control for the first motor and the second motor based on the determining that the parameters of the first motor and the parameters of the second motor differ by at least the certain value.

41. The method according to claim 40, wherein the heterogenous control comprises at least one of:
displaying that the first and second motors are heterogeneous;
operating the inverter by differently setting a limit value of drive current of the first motor and a limit value of drive current of the second motor;
selecting one of the first and second motors as a master to be controlled based on a parameter difference and/or a load current difference;
performing control to compensate d-axis current of the master to be controlled when there is a difference in speed between the first and second motors; and
driving the first and second motors at an optimal control point when there is a parameter difference.
